(19) United States
(12) Patent Application Publication
(10) Pub. No.: US 2023/0320363 A1
(43) Pub. Date: Oct. 12, 2023

(54) METHODS OF USE OF PURIFIED HYDROGEN PEROXIDE GAS IN AGRICULTURAL PRODUCTION, TRANSPORT, AND STORAGE

(71) Applicant: SYNEXIS LLC, Overland Park, KS (US)

(72) Inventors: James D. Lee, Overland Park, KS (US); Douglas J. Bosma, Overland Park, KS (US)

(21) Appl. No.: 18/335,522

(22) Filed: Jun. 15, 2023

Related U.S. Application Data
(63) Continuation of application No. 15/570,677, filed on Oct. 30, 2017, now abandoned.

(51) Int. Cl. A01N 59/00; A01G 7/06; A23B 7/152; A23L 3/3445; A23B 7/144; A01G 22/60; A01G 22/35; A01G 22/40; A01G 22/25; A01G 22/15; A01G 18/00; A01G 22/05; A01G 17/00; A01G 33/00

(52) U.S. Cl. CPC A01N 59/00; A01G 7/06; A23B 7/152; A23L 3/3445; A23B 7/144; A01G 22/60; A01G 22/35; A01G 22/40; A01G 22/25; A01G 22/15; A01G 18/00; A01G 22/05; A01G 17/005; A01G 33/00; Y02A 90/40; Y02A 40/10; A23V 2002/00

(57) ABSTRACT

The present disclosure provides for, and includes, environments for the production, transport and storage of agricultural products including, but not limited to, fruits, vegetables, grains, tubers, decorative plants, flowers and mushrooms. The present disclosure also relates to methods of preparing environments for the preservation and production of agricultural products Also provided are organic agricultural products having reduced levels of microorganisms and residual organic compounds.

### FIELD OF THE INVENTION

The present disclosure relates generally to environments for the production, transport and storage of agricultural products including, but not limited to, fruits, vegetables, grains, tubers, decorative plants, flowers and mushrooms. The present disclosure also relates to methods of preparing environments for the preservation and production of agricultural products Also provided are organic agricultural products having reduced levels of microorganisms and residual organic compounds.

### BACKGROUND OF THE INVENTION

Hydrogen peroxide (H₂O₂) is a strong oxidant and has well known antimicrobial and antiseptic properties as well as activity against organic compounds. H₂O₂ has activity against volatile organic compounds (VOCs) oxidizing, hydrolyzing, and breaking them down. Hydrogen peroxide hydrolyzes, among other things, formaldehyde, ethylene, carbon disulfide, carbohydrates, organophosphorus and nitrogen compounds, and many other more complex organic molecules. H₂O₂ is produced commercially in large quantities as either a colorless liquid or as an aqueous solution, generally from about 3 to 90%. See, Merck Index, 10^{th} Edition at 4705 to 4707. It has recently been shown that H₂O₂ can be produced as a purified hydrogen peroxide gas (PHPG) that is free of ozone, plasma species, or organic species.

PHPG is a non-hydrated gaseous form of H₂O₂ that is distinct from liquid forms of hydrogen peroxide including hydrated aerosols and vaporized forms. Aerosolized and vaporized forms of hydrogen peroxide solution have significantly higher concentrations of H₂O₂, typically comprising greater than 1×10⁶ molecules per cubic micron compared to air containing PHPG that contains between 5 and 25 molecules per cubic micron. Hydrogen peroxide aerosols and vapors are prepared from aqueous solutions of hydrogen peroxide and also differ from PHPG as the aerosols are hydrated and, regardless of the size of the droplet, settle under the force of gravity. Vaporized forms condense and settle. Aerosolized forms of hydrogen peroxide are effective antimicrobial agents however they are generally considered toxic and wholly unsuitable for use in occupied spaces. See for example, Kahnert et al., “Decontamination with vaporized hydrogen peroxide is effective against Mycobacterium tuberculosis,” Lett Appl Microbiol,. 40(6):448-52 (2005). The application of vaporized hydrogen peroxide has been limited by concerns of explosive vapors, hazardous reactions, corrosivity, and worker safety. See Agalloco et al., “Overcoming Limitations of Vaporized Hydrogen Peroxide,” Pharmaceutical Technology, 37(9):1-7 (2013). Further, spaces treated with aerosolized forms, typically at concentrations of between 150 to 700 ppm, remain unsuitable for occupation until the H₂O₂ has been reduced by degradation to water and oxygen. The use of PHPG solves the problem of toxicity of aerosolized H₂O₂. Vaporized and liquid forms of H₂O₂ and can provide continuous safe antimicrobial and oxidative activity.

PHPG is non-hydrated and behaves essentially as an ideal gas capable of diffusing freely throughout an environment to attain an average concentration of about 25 molecules per cubic micron of air when present at about 1.0 ppm. As a gas, PHPG is capable of penetrating most porous materials essentially diffusing freely to occupy any space that is not air tight. The gaseous form of hydrogen peroxide doesn't settle, deposit, or condense when present at concentrations up to 10 ppm. PHPG is completely “green” and leaves no residue as it breaks down the water and oxygen.

Importantly, and in contrast to vaporized and aerosolized forms of H₂O₂, environments containing up to 1 ppm H₂O₂ have been designated as safe for continuous human occupation under current Occupational Safety and Health Administration (OSHA), National Institute for Occupational Safety and Health (NIOSH), or American Conference of Industrial Hygienists (ACIH) standards. It is believed that 10 ppm is also safe for human occupation though not yet recognized by the regulatory authorities. With the advent of PHPG generating devices, appropriate studies can now be performed. The ability to produce effective amounts of PHPG, the safety of PHPG when present as a dilute hydrogen peroxide (DHP) gas combined with its effectiveness as an antimicrobial agent, provides a myriad of useful applications.

U.S. Pat. No. 8,168,122 issued May 1, 2012 and U.S. Pat. No. 8,685,329 issued Apr. 1, 2014, both to Lee, disclose methods and devices to prepare PHPG for microbial control and/or disinfection/remediation of an environment. International Patent Application No. PCT/US2014/038652, published as International Patent Publication No. WO 2014/186805, discloses the effectiveness and use of PHPG for the control of arthropods, including insects and arachnids. International Patent Application No. PCT/US2014/051914, filed Feb. 26, 2015, published as International Patent Publication No. WO/2015/026958, discloses the beneficial effects of PHPG on respiratory health, including increased resistance to infection and increased hypothiocyanate ion in mammalian lungs. The contents of each of the foregoing applications are incorporated herein by reference in their entireties.

In 2013, an estimated 1.3 billion tons of food was wasted, with fifty-four percent of the world's food wastage occurring during production, post-harvest handling and storage. See Food Wastage Footprint: Impacts on Natural Resources (2013) published by the Food and Agriculture Organization of the United Nations available on the interne at www.fao.org. In 1995, the USDA reported that spoliation accounted for about 20% of all US losses of edible foods. Accordingly, even small reductions in spoilage due to microorganisms would have significant economic value.

Growth in the demand for fresh foods, such as fruits and vegetables has increased, and a variety of approaches have been employed to maintain and extend freshness during transport, storage, and processing. Modified atmosphere packaging (MAP), the replacement of ambient air of the food package with a gas or gas mixture, generally reduces perishability during the transport and storage by inhibiting organisms and deteriorative processes. The gases used in MAP are most often combinations of nitrogen (N₂), and carbon dioxide (CO₂) either with, or depleted of, oxygen (O₂). In most cases, the bacteriostatic effect (e.g., suppression of reproduction and growth) is obtained by a combination of decreased O₂ and increased CO₂ concentrations. See, Farber, J. M. 1991. Microbiological aspects of modified-atmosphere packaging technology: a review. J. Food Protect., 54:58-70.

Modified atmospheres (MA) are also employed in non-packaging environments such as shipping containers, for example as refrigerated ocean containers. Generally, the MA approach involves the reduction of oxygen and are described for example in U.S. Pat. Nos. 8,187,653, 6,179,986, and 8,877,271. While reduced oxygen is effective at preventing growth, it would be unable to reduce the load of microorganisms that cause spoilage. That is, the microorganisms largely remain and once the ambient atmosphere is restored, microbial growth and the accompanying spoilage process may resume. There exists a need for improved atmospheres for the transport and storage of agricultural products that reduces the load of microorganisms that cause spoilage.

In addition to microorganisms that cause spoilage, agricultural products can also harbor and transmit pathogenic organisms. Some pathogens enter the plant tissue through mechanical or chilling injuries, or after the skin barrier has been broken down by other organisms. Others, present on the surface of the agricultural product can be ingested or contaminate work surfaces thus leading to illness. Besides causing huge economic losses, some organisms, for example fungal species, may produce toxic metabolites in the affected sites, constituting a potential health hazard for humans. Additionally, vegetables have often served as vehicles for pathogenic bacteria, viruses, and parasites and were implicated in many food borne illness outbreaks. See, Barth et al., “Microbiological Spoilage of Fruits and Vegetables,” in Compendium of the Microbiological Spoilage of Foods and Beverages, Food Microbiology and Food Safety, W. H. Sperber, M. P. Doyle (eds.), Springer Science+Business Media, LLC 2009; Tournas, “Spoilage of Vegetable Crops by Bacteria and Fungi and Related Health Hazards,” Critical Reviews in Microbiology, 31(1):33-44 (2005). Accordingly, methods that reduce, repress, or kill such pathogens are highly desirable. 15 [0011] The existence of harmful pathogens on various agricultural products poses a serious health risk to consumers, particularly when these products are consumed or otherwise introduced into the body fresh. In view of the significant microbial and bacteria problems in whole fruits and vegetables, many retail grocers and restaurant chains have mandated inspections and certifications of whole fruits and vegetables shipped to them from the source supplier. As of 2011, the Center for Disease Control (CDC) estimates some 48 million people get sick, 128,000 are hospitalized, and 3,000 die from foodborne illness. See www.cdc.gov/foodborneburden/index.html. The CDC estimates that about 20% of the illnesses are caused by known pathogens, while 80% are caused by unspecified agents. According to the CDC, eight known pathogens case the majority of illness, hospitalization and death. The top five pathogens accounting for 91% of the illness are norovirus, Salmonella, Costridium perfirnges, Campylobacter spp., and Staphylococcus aureus. The CDC estimates that a 10% reduction in foodborne illness would prevent 5 million illnesses. Accordingly there is a strong need to reduce death and illness due to food-borne pathogens and to decrease liability by decreasing the pathogens on the products sold.

In addition to reducing microorganisms, another approach to reduce spoilage, and increase the shelf life of agricultural products is to prevent ripening or maturation. For some agricultural products such as “fresh” fruits and vegetables, the product may be harvested prematurely and thereby provide time for transport to a final destination prior to spoilage. By shipping unripened horticultural products, the shelf life of the products may be extended, however, these products are often picked so prematurely that even after their long journey, they still are not ready for consumption. Other agricultural products must be ripened before harvesting. Methods to prolong the shelf life of ripened, or nearly ripened, agricultural products such as fruits and vegetables is desirable.

Prior devices and systems designed to combat or reduce many of the above-described problems tend to be inefficient, ineffective, or too expensive, thus rendering them largely inadequate, impractical, and/or inept and severely deficient. The prior art generally utilizes traditional methods largely consisting of washing (for example with a diluted chlorine wash or another anti-bacterial and anti-viral agent), removing and discarding spoiled sections and products, and continued monitoring. More recently irradiation, often referred to as cold pasteurization, has proven adequate to sterilize, but does nothing to enhance or even preserve the food product's good looks, water weight, and flavor. Also, many other problems exist with irradiation, such as expense and consumer reluctance.

Accordingly, what is needed are devices and methods that kill or reduce bacteria, viruses, and other harmful pathogens, as well as prevent spoilage, without sacrificing or reducing those things that are desired and beneficial in the food product. Methods of reducing microorganism loads that do not require irradiation that is both expensive and unacceptable in certain market segments is also desired.

An important regulator of plants and plant parts is the gaseous plant hormone, ethylene (IUPAC Name: ethene). In different contexts and at different times, ethylene participates in a wide variety of plant processes including the ripening and/or senescence of flowers, fruits, and vegetables; abscission of foliage, flowers, and fruit. See Ethylene and Plant Development, Roberts, JA and Tucker GA editors, 1985. Ethylene is also active in the abortion or inhibition of flowering and seed development. Ethylene also stimulates seed germination and breaking of dormancy. For ornamentals such as potted plants, cut flowers, shrubbery, seeds, and dormant seedlings, ethylene is involved in the shortening of life. In some plants, such as peas, ethylene inhibits growth while in others, for example rice, ethylene stimulates growth. Ethylene is also involved in the regulation of auxin and the inhibition of terminal growth and control of apical dominance. Ethylene causes increases in branching and tillering and changes the morphology of plants including changing leaf to stem ratios and lodging. Ethylene is also involved in modifying the susceptibility to plant pathogens such as fungi. There is a need to regulate and control the activity on agricultural products at all stages of development. More specifically, there is a need for preventing premature ripening or over-ripening of agricultural products, preventing abscission of foliage, and extending the life of ornamental plants.

Current methods to improve shelf life include air circulation systems that act to remove ethylene from the air in storage facilities by incorporating ethylene converters or absorbers. Ethylene converters require that the ethylene be circulated through the converter and are therefore incapable of acting at the source of ethylene production (e.g., an ethylene producing fruit). Ethylene converters or absorbers are often catalytic reactors. Examples of ethylene converters include Swingtherm®. Similar ethylene reduction results can be obtained with bead based scrubbers such as particles containing potassium permanganate. Current methods are hampered by the requirement to continuously circulate the ethylene containing air through the system resulting in “dead spots” having limited circulation. This constrains the packing and shipping of the agricultural products. Improved methods are needed.

The well known idiom that a “rotten apple spoils the barrel” reflects the activity of the gaseous hormone ethylene in the ripening process in various agricultural products, including fruits and vegetables. Ripening fruits and vegetables produce this hormone which in turn, acts on adjacent fruits and vegetables causing them to ripen, and in turn, produce yet more ethylene gas. Similarly, molds and fungi which may be present on fruit and which may thrive on over-ripened fruit, can contaminate adjacent fruit and lead to additional spoliation. There exists a need for improved methods to reduce ethylene that acts at the source of production and can be implemented at all stages of production, shipping, and storage of agricultural products.

Prior to sale and consumption, fresh agricultural products spend considerable amounts of time in shipment, storage and processing that provide opportunities to begin treatments to reduce pathogenic organisms, reduce spoilage microorganisms, reduce levels of ethylene and reduce ripening, and to kill or repel unwanted arthropods. The present disclosure provides for methods that can be implemented along all stages of the trail of agricultural products from the field to the fork.

One method for preventing the action of ethylene is to inhibit the ethylene response in an agricultural product by blocking signaling of the ethylene receptor. Examples of irreversible ethylene inhibiting agents include diazocyclopentadiene, disclosed in U.S. Pat. No. 5,100,462, cyclopentadiene disclosed in Sisler et al., Plant Growth, Reg. 9, 157-164, 1990. Both compounds have strong odors and are unstable. U.S. Pat. No. 5,518,988, to Sisler et al. discloses the use of cyclopropene and its derivatives, including methylcyclopropene, as effective blocking agents for ethylene binding. 1-Methylcyclopropene (1-MCP) is a known ripening inhibitor that acts by blocking the binding site of ethylene in the plant tissue. See Blankenship et al., “1-Methylcyclopropene: a review,” Postharvest Biology and Technology, 28: 1-25 (2003). 1-MCP, is unstable (and explosive) and therefore has been difficult to employ. To overcome these problems, U.S. Pat. Nos 6,017,849 and 6,313,068, to Daly et al., disclose encapsulated forms in order to stabilize their reactivity and thereby provide a convenient and safe means of storing, transporting and applying or delivering the active compounds to plants. Improved methods to reduce or eliminate ethylene are highly desirable. The present methods provide for replacement or supplementation of the 1-MCP and related compounds.

### SUMMARY OF THE INVENTION

The present disclosure provides for, and includes, a method for inhibiting an ethylene response in an agricultural product comprising providing DHP gas at a final concentration of at least 0.05 parts per million (ppm) to an enclosed environment containing an agricultural product, and maintaining the concentration of DHP gas in the enclosed environment for a period of time.

The present disclosure provides for, and includes, a method for inhibiting the ripening process of an agricultural product during shipping comprising providing an enclosure for shipping an agricultural product; placing an agricultural product in the enclosure, providing DHP gas at a concentration of at least 0.05 parts per million (ppm) to the enclosure; and maintaining the DHP gas concentration during shipping.

The present disclosure provides for, and includes, a Generally Recognized as Safe (GRAS) method for controlling an infestation of a pathogen on a plant or plant product comprising providing DHP gas at a final concentration of at least 0.05 parts per million (ppm) to an enclosed environment containing an infested plant or plant product; and maintaining the DHP gas at a final concentration of at least 0.05 parts per million (ppm) in the enclosed environment for a time period sufficient to control the pathogen.

The present disclosure provides for, and includes, a GRAS method for preventing the growth of mold on a plant or plant part comprising placing the plant or plant part in a DHP gas containing environment.

The present disclosure provides for, and includes, a GRAS method for treating a pathogen infested plant or plant part comprising placing the plant or plant part in a DHP gas containing environment.

The present disclosure provides for, and includes, a method for controlling a pathogen in an agricultural product during shipping comprising providing DHP gas at a concentration of at least 0.05 parts per million (ppm) to a shipping container containing an agricultural product to prepare a DHP gas containing shipping container, shipping the DHP gas containing shipping container; and maintaining the DHP gas concentration during shipping, wherein the pathogen is controlled.

The present disclosure provides for, and includes, a method of controlling a pathogen in a controlled environment agriculture (CEA) facility comprising providing DHP gas at a final concentration of at least 0.05 parts per million (ppm) to the CEA facility, and maintaining the DHP gas at a final concentration of at least 0.05 parts per million (ppm) for a time period sufficient to control the pathogen.

The present disclosure provides for, and includes, a method for protecting an agricultural product comprising providing DHP gas at a final concentration of at least 0.05 parts per million (ppm) to an enclosed environment, and maintaining the DHP gas at a final concentration of at least 0.05 parts per million (ppm) in the enclosed environment.

The present disclosure provides for, and includes, a method of replacing pesticides and other chemicals used for the control of pathogens and pests of agricultural products during production and storage comprising providing DHP gas at a final concentration of at least 0.05 parts per million (ppm) to an enclosed environment containing an agricultural product and maintaining the DHP gas at a final concentration of at least 0.05 parts per million (ppm) in the enclosed environment containing the agricultural product for a time period.

The present disclosure provides for, and includes, an organic method for crop production comprising providing DHP gas at a final concentration of at least 0.05 parts per million (ppm) to an enclosed environment containing an agricultural product and maintaining the DHP gas at a final concentration of at least 0.05 parts per million (ppm) in the enclosed environment containing the agricultural product for a time period during crop production.

The present disclosure provides for, and includes, an enclosed environment comprising DHP gas at a final concentration of at least 0.05 parts per million (ppm) selected from the group consisting of a CEA facility, a greenhouse, a storage container, a shipping container, a retail store, a distribution center, a wholesale center, a kitchen, a restaurant, a flower shop, a barn, a vehicle, a food processing area, a storage facility, a market storage area, and a market display area.

The present disclosure provides for, and includes, a method for preventing premature aging of a flower during storage comprising providing DHP gas at a final concentration of at least 0.05 parts per million (ppm) to an enclosed environment containing the flower; and maintaining the DHP gas at a final concentration of at least 0.05 parts per million (ppm) in the enclosed environment containing the flower for a time period.

The present disclosure provides for, and includes, a method for controlling an invasive species on or in an agricultural product comprising providing DHP gas at a final concentration of at least 0.05 parts per million (ppm) to an enclosed environment containing an agricultural product, and maintaining the DHP gas at a final concentration of at least 0.05 parts per million (ppm) in the enclosed environment for a time period sufficient to control the invasive species.

The present disclosure provides for, and includes, a method for preparing air dried agricultural products comprising placing an agricultural product in an enclosed environment having DHP gas at a concentration of at least 0.05 parts per million (ppm) and having a relative humidity (RH) of less than 65%, and maintaining the agricultural product in the enclosed environment until the water content of the agricultural product is reduced.

The present disclosure provides for, and includes, air dried agricultural products having reduced levels of bacteria, fungi, and virus.

The present disclosure provides for, and includes, a method for reducing the concentration of a VOC in an enclosed environment comprising: providing DHP gas to an enclosed environment at a final concentration of at least 0.05 parts per million (ppm) and maintaining said DHP gas containing environment for a time period wherein the concentration of a VOC in the enclosed environment is reduced by oxidation.

### BRIEF DESCRIPTION OF THE DRAWINGS

The present invention is disclosed with reference to the accompanying drawings, wherein:

FIGS. 1A and 1B are diagrams of exemplary devices according to the present disclosure. FIG. 1A illustrates an inline device for installation in a heating, ventilation and air conditioning system. FIG. 1B illustrates an exemplary standalone device suitable for the compositions and methods of the present disclosure.

FIGS. 2A and 2B are images of strawberries stored for 5 days without DHP gas or with DHP gas according to the present disclosure.

### DETAILED DESCRIPTION

Unless defined otherwise, technical and scientific terms as used herein have the same meaning as commonly understood by one of ordinary skill in the art. One skilled in the art will recognize many methods can be used in the practice of the present disclosure. Indeed, the present disclosure is in no way limited to the methods and materials described. Any references cited herein are incorporated by reference in their entireties. For purposes of the present disclosure, the following terms are defined below.

As used herein, PHPG and DHP gas may be used interchangeably. Generally, devices produce PHPG and environments that have DHP gas are provided. The PHPG as used herein is non-hydrated, and substantially free of ozone, plasma species, and organic species.

As used herein, “a reduction” of pathogen, bacterial, fungal, or VOC levels, means that the level of each is reduced relative to the levels found on agricultural products that have not been exposed, shipped, stored or processed in an environment having PHPG. In some aspects, a reduction may occur killing the pathogen, bacteria, fungus, or destruction of VOC, or may be the result of suppressed growth of the pathogen, bacteria, or fungus.

As used herein, the term “at least a partial reduction” of pathogen, bacterial, fungal, or VOC levels, means that the level of each is reduced by at least 25% relative to the levels found on agricultural products that have not been exposed, shipped, stored or processed in an environment having PHPG. In some aspects, a reduction may occur killing the pathogen, bacteria, fungus, or destruction of VOC, or may be the result of suppressed growth of the pathogen, bacteria, or fungus. Also as used herein, it is understood that in environments having multiple populations of pathogens, bacteria, and fungi, each population may be “partially reduced” independently.

As used herein, the term “a substantial reduction” of pathogens, bacteria, fungi, or VOC levels, means that the level of each is reduced by at least 75% relative to the levels found on agricultural products that have not been exposed, shipped, stored or processed in an environment having PHPG. In some aspects, a reduction may occur killing the pathogen, bacteria, fungus, or destruction of VOC, or may be the result of suppressed growth of the pathogen, bacteria, or fungus. Also as used herein, it is understood that in environments having multiple populations of pathogens, bacteria, and fungi, each population may be “substantially reduced” independently.

As used herein, the term “an effective elimination” of a pathogen, bacteria, fungus, or VOC, means that the level of each is reduced by greater than 95% relative to the levels found on agricultural products that have not been exposed, shipped, stored or processed in an environment having PHPG. In some aspects, a reduction may occur killing of the pathogen, bacteria, fungus, or destruction of VOC, or may be the result of suppressed growth of the pathogen, bacteria, or fungus. Also as used herein, it is understood that in environments having multiple populations of pathogens, bacteria, and fungi, each population may be “effectively eliminated” independently. An effective amount of PHPG is preferably capable of providing at least a partial reduction, more preferably a substantial reduction, or most preferably effective elimination of a pathogen, bacteria, fungus, or VOC.

As used herein, the singular form “a,” “an” and “the” includes plural references unless the context clearly dictates otherwise. For example, the term “a bacterium” or “at least one bacterium” may include a plurality of bacteria, including mixtures thereof. In another example, the term “a fungi” or “at least one fungi” may include a plurality of bacteria, including mixtures thereof. Similarly, “a VOC” or “at least one VOC” may include multiple VOCs and mixtures thereof.

The present disclosure provides for methods and compositions for the inhibition of ethylene responses in agricultural products by providing DHP gas at a final concentration of at least 0.05 parts per million (ppm) to an enclosed environment containing said agricultural product. In certain aspects, the enclosed environment can provide DHP gas at a final concentration of at least 0.05 ppm before placing an agricultural product in the enclosed environment for a period of time. In other aspects, the agricultural product is placed in the enclosed environment and the DHP gas provided until the concentration reaches at least 0.05 ppm and maintaining the DHP gas in said environment at a concentration of at least 0.05 ppm for a period of time. In certain aspects, the DHP gas level can be up to 10 ppm. In certain aspects, the DHP gas level ranges between 0.05 and 10 ppm. The specification provides for, and includes, additional levels of DHP gas depending on the application. Suitable levels of

DHP gas are provided below, for example at paragraphs [0099] to [00101].

Among the uses of the present disclosure are, for example, plant growth regulation. Also among the uses of the present disclosure are, for example, modifying a variety of ethylene responses such as, for example, the ripening and/or senescence of flowers, fruits, and vegetables; abscission of foliage, flowers, and fruit; the shortening of life of ornamentals such as potted plants, cut flowers, shrubbery, seeds, and dormant seedlings; in some plants (e. g., pea) the inhibition of growth, the stimulation of growth (e.g., rice), auxin activity, inhibition of terminal growth, control of apical dominance, increase in branching, increase in tillering, changing the morphology of plants, modifying the susceptibility to plant pathogens such as fungi, changing bio-chemical compositions of plants (such as increasing leaf area relative to stem area), abortion or inhibition of flowering and seed development, lodging effects, stimulation of seed germination and breaking of dormancy, and hormone or epinasty effects.

As will be understood by a person of ordinary skill in the art, agricultural products, such as plants, plant parts, and fungi, exhibit a wide variety of responses to ethylene. While specific aspects are provided below in detail, the following aspects are generally considered within the scope of the present disclosure.

As will be understood by a person of ordinary skill, the degree of inhibition of ethylene signaling and the resultant phenotypic effects depends on a variety of variables. Among the important variables are the final concentration of DHP gas to which the agricultural product is exposed. In aspects according to the present disclosure, the final concentration of DHP gas may range from at least 0.05 ppm to 10 ppm DHP gas. Not to be limited by theory, DHP gas at a concentration of at least 0.05 ppm oxidizes ethylene thereby inhibiting the various ethylene signaling pathways. Also not to be limited by theory, it is thought that DHP gas, as a non-hydrated gas diffusing throughout the air volume, oxidizes the ethylene close to its source of production. By acting at the source, the DHP gas is particularly effective at inhibiting ethylene signaling.

A second variable is the time of exposure to DHP gas. In certain aspects, the agricultural product is exposed continuously, for example to maintain dormancy or to prevent maturation and ripening. In other aspects, the DHP gas is provided during certain periods and then the agricultural product is removed or the DHP gas allowed to dissipate. For example, during early growth stages a growing plant is exposed to DHP gas to inhibit apical dominance and to promote branching, and then removed so that normal growth may result. Not to be limited by theory, it is thought that this will increase the number and yield of leafy agricultural products.

The present disclosure provides for, and includes, methods and compositions to inhibit an ethylene response to increase yields in a plant grown in an enclosed environment having at least 0.05 ppm DHP gas. Examples of plants that have increased yield in response to inhibition of ethylene signaling includes but is not limited to small grains, particularly oats (Avena sativa), wheat (Triticum aestivum), and barley (Hordern spp.); and of increasing yields of other types of plants, such as beans and cotton (Gossypium hirsurum). In an aspect, the enclosed environment is a greenhouse, a cold frame, or a hoop house.

The present disclosure provides for, and includes, methods and compositions to inhibit an ethylene response to modulate auxin activity. In an aspect, the present disclosure provides for inducing sprouting of underground rhizomes of monocotyledonous and dicotyledonous plants. In an aspect, the methods provide for inducing cell proliferation and for inducing rooting.

The present disclosure provides for, and includes, methods and compositions to inhibit an ethylene response to inhibit terminal growth, control apical dominance, increase branching and increase tillering in agricultural products that are growing plants. These types of plant growth responses can be produced on a variety of plant species when they are exposed to at least 0.05 ppm DHP gas for a period of time. In certain aspects, the plant species include, but are not limited to, privet (Ligustrum ovalifolium), blueberry (Vaccinum corymhosum), azalea (Rhododendron ohrusum), soybeans (Glycine mas.), snapbeans (Phaseolus vulgaris), tomatoes (Lycopersicon esculentum), alligator weed (Alternanthua philoxeroides) and monocotyledons such as rice (Oryza sativa), johnsongrass (Sorghum halopense) and wild oats (Avena fatua). In certain aspects, a growing plant is a plant wherein the lead bud is removed (e.g., by pinching) and exposure to at least 0.05 ppm DHP gas prevents the auxiliary buds from establishing dominance as a lead bud. The present disclosure also provides from exposing a growing plant to DHP gas to retard the activity of the lead bud for a time period, and then growing the plant in the absence of DHP gas to restore the lead bud to normal growth, with production of normal flowers and normal fruit. The benefit of growing first in the presence of DHP gas and then providing for growth in the absence of DHP gas avoids the permanent loss of buds associated with pinching. In certain aspects, plant species, such as tobacco (Nicotiana tabacum) and Chrysanthemum (Chrysanthemum sp.) treated with DHP gas according to the methods of the present disclosure inhibit lateral bud formation and prevent sucker growth.

The present disclosure provides for, and includes, methods and compositions to inhibit an ethylene response to improve the overall biochemical composition of a growing plant. It is known that inhibiting ethylene signaling increases leaf area relative to the stem area of many plants. Accordingly, the methods and compositions provide for inhibiting ethylene signaling by treating a growing plant with DHP gas at a concentration of at least 0.05 ppm during a growth period to increase the leaf to stem ratio. In other aspects, inhibition of ethylene signaling increases the total protein on a per plant basis. In another aspect, the methods and compositions provide for modification of the protein, carbohydrate, fat, nicotine and sugar within the treated plant by growing the plant in the presence of at least 0.05 ppm DHP gas for a period of time.

The present disclosure provides for, and includes, methods and compositions to inhibit an ethylene response to inhibit abscission of foliage, flowers and fruit by exposing an agricultural product to at least 0.05 ppm DHP gas or providing an enclosed environment having at least 0.05 ppm DHP gas. It is well known that the abscission zone of plants are sensitive to ethylene signaling. Accordingly, by inhibiting ethylene signaling using DHP gas, abscission can be delayed or even prevented. Examples of plants wherein abscission can be delayed or prevented include cotton, roses, privet, apples, citrus, and Brussel sprouts once the leaves have attained a mature state. Similarly, plants wherein abscission of flowers and/or fruit can be delayed by growth and treatment with DHP include, but are not limited to apples (Malus domestica), pears (Pyrus communis), cherries (Prunus avium), pecans (Carva illinoensis), grapes (Vitis vinifera), olives (Olen europaea), coffee (Coffea arahica) and snapbeans (Phaseolus vulgaris). Accordingly, the methods and compositions of the present disclosure provide for the regulation of abscission responses and can be used to regulate flower production as an aid in harvesting fruit.

The present disclosure provides for, and includes, methods and compositions to inhibit an ethylene response to inhibit ripening in fruit by exposing an agricultural product to at least 0.05 ppm DHP gas or providing an enclosed environment having at least 0.05 ppm DHP gas. In certain aspects, the methods and compositions inhibit the changes in color associated with the ripening process in fruit. In certain aspects, the fruit may be picked or unpicked. As provided in further detail below, the ripening of fruit may be delayed thus preserving the fruit. In other aspects, the time to peak ripeness may be delayed or even prevented until exposure to the DHP gas is removed. For example, ripening in apples (Malus domestica), pears (Pyrus communis), cherries (Primus avium), bananas and pineapples (Ananas comosus) may be prevented or delayed, or both. In other aspects, the unripe color of a fruit may be maintained, for example the green color from harvestable fruit such as tomatoes (Lycopersicon esculentum) and regreened citrus such as oranges (Citrus sinensis) and lemons (Citrus limon) may be delayed. Additional examples and specific aspects are provided below.

The present disclosure provides for, and includes, methods and compositions to inhibit an ethylene response to prevent or inhibit flowering and fruiting by exposing an agricultural product to at least 0.05 ppm DHP gas or providing an enclosed environment having at least 0.05 ppm DHP gas. For example, decreased flowering and fruiting in a number of economic crops, such as soybeans (Glycine max), snapbeans (Phaseolus vulgaris). kidney beans (Phaseolus vulgaris) and zinnias (Zinnia elegans) can be attained using the methods and compositions of the present disclosure.

The present disclosure provides for, and includes, methods and compositions to inhibit an ethylene response to promote or induce flowering and fruiting by exposing an agricultural product to at least 0.05 ppm DHP gas or providing an enclosed environment having at least 0.05 ppm DHP gas. In an aspect, 0.05 ppm of DHP gas is provided to Johnson grass (Sorghum lzalepense) to promote or induce flowering and fruiting.

The present disclosure provides for, and includes, methods and compositions to inhibit an ethylene response to promote lodging by exposing an agricultural product to at least 0.05 ppm DHP gas or providing an enclosed environment having at least 0.05 ppm DHP gas.

The present disclosure provides for, and includes, methods and compositions to inhibit an ethylene response to prevent or inhibit seed germination and breaking of dormancy by exposing an agricultural product to at least 0.05 ppm DHP gas or providing an enclosed environment having at least 0.05 ppm DHP gas. In an aspect, providing DHP gas at a concentration of at least 0.05 ppm inhibits the germination of, for instance, lettuce seed and to maintain the dormancy of tubers such as seed potatoes. As will be discussed below, treatment of an agricultural product such as a seed reduces the microbial load on the seed surface. Accordingly the present disclosure provides for methods to reduce or eliminate undesired microorganisms on the seed surface prior to planting.

The present disclosure provides for, and includes, methods and compositions to inhibit an ethylene response to prevent freeze injury by exposing an agricultural product to at least 0.05 ppm DHP gas or providing an enclosed environment having at least 0.05 ppm DHP gas. In an aspect, DHP gas inhibits ethylene signaling by reducing or eliminating ethylene produced in response to cold temperatures. In an aspect, the present disclosure provides for provide resistance to freeze injury, for example in lima beans or citrus.

The present disclosure provides for, and includes, methods and compositions to inhibit an ethylene response to prevent hormone or epinasty effects in certain plants by exposing a growing agricultural product to at least 0.05 ppm DHP gas or providing an enclosed environment having at least 0.05 ppm DHP gas. In an aspect, the methods prevent epinasty in tomatoes (Lycopersicon esculentum).

The present disclosure provides for, and includes, methods and compositions to inhibit an ethylene response together with other plant regulators by exposing a growing agricultural product to at least 0.05 ppm DHP gas or providing an enclosed environment having at least 0.05 ppm DHP gas and applying a growth regulator. In an aspect, the agricultural product may be treated with at least 0.05 ppm DHP gas together with one or more plant growth regulators selected from the group consisting of maleic hydrazide, N-dimethyl-amino-succinic acid, gibberellic acid and naphthalene acetic acid. As provided herein, interactions of DHP gas (e.g., inhibition of ethylene signaling) may be synergistic or antagonistic responses in various agricultural product. As appropriate, the levels of plant growth regulators may be increased to account for destruction via oxidation by DHP gas.

The present disclosure provides for, and includes, methods and compositions to inhibit an ethylene response to enhance the response to herbicides by exposing a growing agricultural product to at least 0.05 ppm DHP gas or providing an enclosed environment having at least 0.05 ppm DHP gas in the presence of a herbicide. In an aspect, the herbicide may be aminotriazole. The present disclosure also provides for, and includes, methods and compositions to inhibit an ethylene response to inhibit the response to herbicides by exposing a growing agricultural product to at least 0.05 ppm DHP gas or providing an enclosed environment having at least 0.05 ppm DHP gas in the presence of a herbicide.

The present disclosure provides for, and includes, methods and compositions to inhibit an ethylene response to improve disease resistance by exposing a growing agricultural product to at least 0.05 ppm DHP gas or providing an enclosed environment having at least 0.05 ppm DHP gas in the presence of a herbicide.

The present disclosure also provides for, and includes, methods and compositions to prevent ethylene signaling by reducing or eliminating ethylene at it source. Not to be limited by theory, agricultural produces that express the gene 1-aminocyclopropane-1-carboxylic acid oxidase (ACO) are potential sources of ethylene. Accordingly, in an aspect, ethylene signaling is inhibited by exposing source agricultural products expressing ACO to DHP gas at a concentration of at least 0.05 ppm.

The present disclosure provides for, and includes, methods for inhibiting the ripening process of an agricultural product comprising providing DHP gas at a final concentration of at least 0.05 parts per million (ppm) to an enclosed environment containing said agricultural product; and maintaining the DHP gas at a final concentration of at least 0.05 parts per million (ppm) in the enclosed environment containing the agricultural product for a time period. It will be understood, that even a short period of exposure will result in destruction of the ethylene gas that is the hormone responsible for ripening of agricultural products.

As used herein, “ripening” means the process by which a fruit or vegetable becomes more palatable by generally becoming sweeter and less bitter, changing color, and becoming softer. In certain aspects, ripening is associated with changes in changes in pH, with acids being degraded and a general decrease in acid content. During the ripening process, starches are converted to simpler sugars. The ripening process is well known to a person of ordinary skill and a person of ordinary skill would recognize that ripening processes for specific agricultural products are known.

As used herein, “inhibiting the ripening process”, means that the time to optimal ripeness is delayed relative to a fruit that is not exposed to DHP gas when stored under otherwise identical conditions. In certain aspects, the ripening process can be completely inhibited by the destruction of the plant hormone, ethylene. Thus, peak ripeness can be delayed by a week or more. In other aspects, inhibition of the ripening process delays the time to peak ripeness by at least a day. In another aspect, inhibition of the ripening process delays the time to peak ripeness by at least two days. In yet another aspect, inhibition of the ripening process delays the time to peak ripeness by at least three days. In other aspects, the inhibition of the ripening process delays the time to peak ripeness by at least four days or at least five days. In further aspects, inhibition of the ripening process delays the time to peak ripeness by at least 6 days. It will understood by a person of skill in the art that the length of time achievable using the methods of the present disclosure depends on the type of agricultural product and the DHP gas concentration that the agricultural product is maintained. As provided, increasing the level of DHP gas during storage increases the inhibition of ripening and extends the time to peak ripeness, limited by whether any ethylene remains to be removed.

The present disclosure further provides for, and includes, methods for inhibiting the ripening process of an agricultural fruit or vegetable product comprising providing DHP gas at a final concentration in the range of 0.3 to 10 parts per million (ppm) to an enclosed environment containing said agricultural fruit or vegetable product; and maintaining the DHP gas at a final concentration in the range of 0.3 to 10 parts per million (ppm) in the enclosed environment containing the agricultural fruit or vegetable product for a time period that delays peak ripeness by at least two days.

The present disclosure further provides for inhibiting the ripening process of an agricultural product by reducing the exposure of agricultural products to ethylene, generally produced by ripening agricultural products. As an agricultural product ripens (or is wounded or injured), it produces ethylene and becomes a source of ethylene that can autologously increase the ripening rate of the source itself, or act heterologously on another agricultural product. Not to be limited by theory, it has been generally understood that the ripening process is controlled by ethene, C₂H₄, commonly known as ethylene, which is a colorless gas and is a natural plant hormone. It is naturally produce by plants and requires the activity of 1-aminocyclopropane-1-carboxylic acid oxidase (ACO), also known as ethylene forming enzyme. Agricultural products that express ACO can act as a source of ethylene. Ethylene acts by binding to a family of dimeric transmembrane receptors that consists of five members. Agricultural products expressing one or more of the dimeric transmembrane receptors (ETR's) can respond to the presence of ethylene, and among other things, initiate or accelerate ripening. Agricultural products may express both an ACO and an ETR and can thus increase its own rate of ripening, as well as agricultural products nearby. In other aspects, the source agricultural product and the recipient agricultural product may be different.

In aspects according to the present disclosure, the source of ethylene can be a type of agricultural product that is different than the recipient agricultural product. In an aspect, a source agricultural product is an agricultural product that expresses the gene 1-aminocyclopropane-1-carboxylic acid oxidase (ACO). In certain aspect, a method for inhibiting the ripening process includes reducing the level of ethylene produced by a source agricultural product by converting it to carbon dioxide and water. Accordingly the ethylene produced is prevented from affecting the responsive agricultural product.

Methods according to embodiments of the present invention inhibit the ripening or senescence of agricultural products, or both. As used herein, ripening includes the ripening of the agricultural products while still on the agricultural product bearing plant and the ripening of the agricultural products after having been harvested from the agricultural product bearing plant. Agricultural products which may be treated by the method of the present invention to inhibit ripening and/or senescence include leafy green vegetables such as lettuce (e.g., Lactuea sativa), spinach (Spinaca oleracea), and cabbage (Brassica oleracea), various roots, such as potatoes (Solanum tuberosum) and carrots (Daucus), bulbs, such as onions (Allium sp.), herbs, such as basil (Ocimum basilicum), oregano (Origanum vulgare), dill (Anethum graveolens), as well as soybean (Glycine max), lima beans (Phaseolus limensis), peas (Lathyrus spp.), corn (Zea mays), broccoli (Brassica oleracea italica), cauliflower (Brassica oleracea botrytis), and asparagus (Asparagus officinalis).

As used herein, an “agricultural product”, includes cultivated as well as gathered plant products and plants. Included in agricultural products are plants and parts of plants grown or gathered for food, either for humans or animals. Also provided by the present disclosure are agricultural products grown for decoration such as for cut flowers, decorative plants, or dried plants. As used herein, agricultural products include plants for use as raw materials, including but not limited to, for example, plants grown for biofuel production, and fiber crops.

As used herein, agricultural products include cultivated and gathered plants and plant products used for human or non-human food. As used herein agricultural products gathered or cultivated for food include roots, tubers, rhizomes, bulbs, corms, stems, branches, leaf stems, bracts, leaf sheaths, leaves, needles, blooms, buds, flowers, petals, fruits, seeds, and edible fungi. The methods and compositions disclosed herein and described in detail below, can be used to prolong the freshness (e.g., delay ripening), kill or prevent infestation by pathogens or pests, repel pests, kill fungi, molds, bacteria and viruses, and control invasive species. Notably, the methods and compositions of the present disclosure are completely natural, “green”, non-toxic and safe, leaving no residue whatsoever beyond water and oxygen. Importantly, the methods and compositions of the present disclosure are suitable for use in occupied areas and have been determined by the Occupational Safety and Health Administration (OSHA), the National Institute of Occupational Safety and Health (NIOSH), and the Environmental Protection Agency (EPA) to be safe.

Use of the methods and compositions of the present disclosure are provided for each of the agricultural products recited herein, either individually, such as during shipment from the field, or as part of variety when shipped or stored in a distribution or retail facility. In the interests of economy, specific agricultural products are recited as part of one or more lists and the inclusion of the agricultural product in a list should not be construed as being contemplated as anything other than the use of each individual agricultural product according the methods and compositions of the present disclosure. More specifically, even where the present disclosure recites any one individual agricultural product as a specific aspect, it should be understood by one of ordinary skill without any doubt, that each individual agricultural product is similarly disclosed, whether recited in a list or not.

The present disclosure further provides for, and includes, methods for producing an agricultural product for human consumption comprising harvesting an agricultural product for human consumption, providing DHP gas at a final concentration in the range of 0.3 to 10 parts per million (ppm) to an enclosed environment containing said harvested agricultural product; and maintaining the DHP gas at a final concentration in the range of 0.3 to 10 parts per million (ppm) in the enclosed environment containing the harvested agricultural product. The disclosure further provides for, and includes, a storage container providing an enclosed environment comprising a harvested agricultural product for human consumption and DHP gas at a final concentration in the range of 0.3 to 10 parts per million (ppm).

The present disclosure provides for and includes, agricultural products that are vegetables. As used herein, a “vegetable” includes agricultural products generally consumed as food and includes, but is not necessarily limited to roots, tubers, bulbs, corms, stems, leaf stems, leaf sheaths, leaves, buds, flowers, fruits, seeds, and edible fungi. It is generally understood that for certain edible plants, the fruit, seeds, leaves and other parts may be consumed. Included among the vegetables suitable for the methods and compositions of the present disclosure are leafy vegetables, including but not limited to lettuce, cabbages, bok choy, spinach, mustard greens, collard greens. Other leafy vegetables according to the present disclosure include but are not limited to, Brussels sprout, ong choi, puha, radicchio, silverbeet, sorrel, tat soi, tong ho, watercress, witloof, and wong nga back (Peking cabbage).

The present disclosure also provides for the methods and compositions for use with legumes, including the seed (bean) and the sprouts thereof. In certain aspects, the methods and compositions are particularly suited for application to uncooked, raw agricultural products wherein pathogens, fungi, molds, bacteria and viruses that pose a potential health risk may be reduced or eliminated. In certain aspects, raw agricultural products suitable for reduction or elimination of pathogens, fungi, molds, bacteria and viruses that pose a potential health risk include leafy vegetables, sprouts, and fruits.

In aspects according the present disclosure an agricultural product may be a bulb. In certain aspects, the bulb may be fennel, garlic, leek, onion, shallot, or a spring onion. The present disclosure also provides for agricultural products that are flowers, including but not limited to artichoke (globe), broccoflower, cauliflower, broccoli, choi sum, courgette or other squash flowers, and sprouting broccoli. In other aspects, the agricultural product is a seed including for example, bean (green, French, butter, snake), broad bean, pea, snow pea, and sweet corn. In an aspect, the agricultural product is stem, for example asparagus, celery or kohlrabi.

The methods and compositions of the present disclosure can be used to prolong the freshness (e.g., delay ripening), kill or prevent infestation by pathogens or pests, repel pests, kill fungi, molds, bacteria and viruses, and control invasive species of one or more of the following agricultural products: achoccha, amaranth, angelica, anise, apple, arrowroot, arrugula, artichoke, globe, artichoke, jerusalem, asparagus, atemoya, avocado, balsam apple, balsam pear, bambara groundnut, bamboo, banana, plantains, barbados cherry, beans, beet, blackberry, blueberry, bok choy, boniato, broccoli, Chinese broccoli, raab broccoli, Brussels sprouts, bunch grape, burdock, cabbage, cabbage, sea-kale, swamp cabbage, calabaza, cantaloupes, muskmelons, capers, carambola (star fruit), cardoon, carrot, cassava, cauliflower, celeriac, celery, celtuce, chard, chaya, chayote, chicory, Chinese jujube, chives, chrysanthemum, chufa, cilantro, citron, coconut palm, collards, comfrey, corn salad, corn, cuban sweet potato, cucumber, cushcush, daikon, dandelion, dasheen, dill, eggplant, endive, eugenia, fennel, fig, galia muskmelon, garbanzo, garlic, gherkin, ginger, ginseng, gourds, grape, guar, guava, hanover salad, horseradish, huckleberry, ice plant, jaboticaba, jackfruit, jicama, jojoba, kale, kangkong, kohlrabi, leek, lentils, lettuce, longan, loquat, lovage, luffa gourd, lychee, macadamia, malanga, mamey sapote, mango, martynia, melon, casaba, melon, honeydew, momordica, muscadine grape, mushroom, muskmelons, mustard, mustard collard, naranjillo, nasturtium, nectarine, okra, onion, orach, oranges, papaya, paprika, parsley, parsley root, parsnip, passion fruit, peach, plum, peas, peanuts, pear, pecan, pepper, persimmon, pimiento, pineapple, pitaya, pokeweed, pomegranate, potato, sweet potato, pumpkin, purslane, radicchio, radish, rakkyo, rampion, raspberry, rhubarb, romaine lettuce, roselle, rutabaga, saffron, salsify, sapodilla, sarsaparilla, sassafrass, scorzonera, sea kale, seagrape, shallot, skirret, smallage, sorrel, soybeans, spinach, spondias, squash, strawberries, sugar apple, swamp cabbage, sweet basil, sweet corn, sweet potato, swiss chard, tomatillo, tomato, tree tomato, truffles, turnip, upland cress, water celery, waterchestnut, watercress, watermelon, yams, and zucchini.

The present disclosure further provides for, and includes, methods for producing an agricultural vegetable product for human consumption comprising harvesting the agricultural vegetable product for human consumption, providing DHP gas at a final concentration in the range of 0.3 to 10 parts per million (ppm) to an enclosed environment containing said harvested agricultural vegetable product; and maintaining the DHP gas at a final concentration in the range of 0.3 to 10 parts per million (ppm) in the enclosed environment containing the harvested agricultural vegetable product. The disclosure further provides for, and includes, a storage container providing an enclosed environment comprising a harvested agricultural vegetable product for human consumption and DHP gas at a final concentration in the range of 0.3 to 10 parts per million (ppm).

In aspects according to the present disclosure the agricultural product is a fruit. As used herein, a “fruit” means the reproductive structure of an angiosperm which develops from the ovary and accessory tissue, which surrounds and protects the seed. A fruit according to the present disclosure may be fresh or dried. As used herein, the term fruit encompasses all types of tropical fruit, tree fruit, citrus fruit, berries, and melons. Also included and provided for are simple, aggregate, multiple, or accessory fruits. As used herein, fruits include fleshy simple fruits such as, but not limited to, tomato, banana, grapes, drupes (almonds, peaches,), plums, pomes (pears, apples, etc.). Fruits of the present disclosure also include fleshy multiple fruits such as, but not limited to, figs, pineapple and mulberry. Also contemplated and provided by the present disclosure are fleshy aggregate fruits (e.g., strawberry, blackberry, custard apple).

The present disclosure provides for use of the methods and compositions to prolong the freshness (e.g., delay ripening), kill or prevent infestation by pathogens or pests, repel pests, kill fungi, molds, bacteria and viruses, and control invasive species of climateric fruits. Climateric fruits, include but are not limited to an apple, an apricot, and avocado, a banana, a breadfruit, a custard apple, a durian, a feijoa, a fig, a guava, a honeydew melon, a jackfruit, a kiwifruit, a mangosteen, a mango, a nectarine, a papaya, a passionfruit, a peach, a pear, a persimmon, a plantain, a plum, a quince, a cantaloupe, a sapodilla, a sapote, a tomato, or a watermelon. The methods and compositions disclosed herein and described in detail below, can be used to prolong the freshness (e.g., delay ripening), kill or prevent infestation by pathogens or pests, repel pests, kill fungi, molds, bacteria and viruses, and control invasive species.

The present disclosure provides for use of the methods and compositions to prolong the freshness (e.g., delay ripening), kill or prevent infestation by pathogens or pests, repel pests, kill fungi, molds, bacteria and viruses, and control invasive species of non-climateric fruits. Non-climateric fruits include, but are not limited to, a blackberry, a blueberry, cacao, a cactus pear, a bell pepper, a cherry, a chili, a cucumber, an eggplant, a grape., a grapefruit, a lemon, a lime, a longan, a loquat, a lychee, a mandarin, an olive, an orange, a pepino, a pineapple, a pitaya, a pomegranate, a pumpkin, a rambutan, a raspberry, a squash, a strawberry, a tomarillo, or a zucchini.

Fruits which may be treated by the methods of the present invention to inhibit ripening include tomatoes (Lycopersicon esculentum), apples (Malus domestica), bananas (Musa sapientum), pears (Pyrus communis), papaya (Carica papya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia. chinenus), melons such as cantaloupes (C. cantalupensis) and musk melons (C. melo), pineapples (Aranae comosus), persimmon (Diospyros sp.) and raspberries (e.g., Fragaria or Rubus ursinus), blueberries (Vaccinium sp.), green beans (Phaseolus vulgaris), members of the genus Cucumis such as cucumber (C. sativus) and avocados (Persea americana).

The present disclosure further provides for, and includes, methods for producing an agricultural fruit product for human consumption comprising harvesting the agricultural fruit product for human consumption, providing DHP gas at a final concentration in the range of 0.3 to 10 parts per million (ppm) to an enclosed environment containing said harvested agricultural fruit product; and maintaining the DHP gas at a final concentration in the range of 0.3 to 10 parts per million (ppm) in the enclosed environment containing the harvested agricultural fruit product. The disclosure further provides for, and includes, a storage container providing an enclosed environment comprising a harvested agricultural fruit product for human consumption and DHP gas at a final concentration in the range of 0.3 to 15 10 parts per million (ppm).

The methods and compositions disclosed herein can be used to prolong the freshness (e.g., delay ripening), kill or prevent infestation by pathogens or pests, repel pests, kill fungi, molds, bacteria and viruses, and control invasive species of agricultural products that are tubers, roots or fungi. In an aspect, the agricultural product is a root, including without limitation beetroot, carrot, celeriac, daikon, parsnip, radish, swede, and turnip. In an aspect, the agricultural product is a fungus, including without limitation, button white, Swiss brown, cup (opened not flat), enoki, oyster, Portabello (brown flat or cup), shiitake, black truffle and white truffle. In an aspect, the agricultural product is a tuber, including without limitation, an earth gem, a Jerusalem artichoke, a kumara, a potato, or a yam.

The present disclosure provides for, and includes, providing DHP gas to an enclosed environment to prevent ripening by reducing or eliminating ethylene gas produced by agricultural products expressing ACO. In an aspect, the agricultural product is selected from the group consisting of an apple, an apricot, an avocado, a ripe banana, a blueberry, a cantaloupe, a cherimoya, a cranberry, a fig, a green onion, a guava, a grape, a honeydew, a kiwifruit, a mango, a mangosteen, a nectarine, a papaya, a passion fruit, a peach, a pear, a persimmon, a plum, a potato, a prune, a quince, and a tomato.

The present disclosure provides for, and includes, providing DHP gas to an enclosed environment to prevent ripening by reducing or eliminating ethylene gas produced by one agricultural product and acting on a second agricultural product. In certain aspects, ripening may be inhibited in an asparagus, an unripe banana, a blackberry, broccoli, a Brussels sprout, a cabbage, a carrot, cauliflower, a chard, a cucumber, an eggplant, endive, garlic, a green bean, kale, a leafy green, a leek, lettuce, okra, an onion, parsley, a pea, a pepper, a raspberry, spinach, a squash, a strawberry, a sweet potato, watercress, or a melon.

The present disclosure further provides for, and includes, methods for producing an agricultural tuber, root or fungal product for human consumption comprising harvesting the agricultural tuber, root or fungal product for human consumption, providing DHP gas at a final concentration in the range of 0.3 to 10 parts per million (ppm) to an enclosed environment containing said harvested agricultural tuber, root or fungal product; and maintaining the DHP gas at a final concentration in the range of 0.3 to 10 parts per million (ppm) in the enclosed environment containing the harvested agricultural tuber, root or fungal product. The disclosure further provides for, and includes, a storage container providing an enclosed environment comprising a harvested agricultural tuber, root or fungal product for human consumption and DHP gas at a final concentration in the range of 0.3 to 10 parts per million (ppm).

Ornamental plants which may be treated by the method of the present invention to inhibit senescence and/or to prolong flower life and appearance (e.g., delay wilting), include potted ornamentals, and cut flowers. Potted ornamentals and cut flowers which may be treated with the present invention include azalea (Rhododendron spp.), hydrangea (Macrophylla hydrangea), hybiscus (Hibiscus rosasanensis), snapdragons (Antirrhinum sp.), poinsettia (Euphorbia pulcherima), cactus (e.g., Cactaceae schlumbergera truncata), begonias (Begonia sp.), roses (Rosa spp.), tulips (Tulipa sp.), daffodils (Narcissus spp.), petunias (Petunia hybrida), carnation (Dianthus caryophyllus), lily (e.g., Lilium sp.), gladiolus (Gladiolus sp.), alstroemeria (Alstoemeria brasiliensis), anemone (e.g., Anemone blanda), columbine (Aquilegia sp.), aralia (e.g., Aralia chinensis), aster (e.g., Aster carolinianus), bougainvillea (Bougainvillea sp.), camellia (Camellia sp.), bellflower (Campanula sp.), cockscomb (celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae. The methods and compositions disclosed herein and described, can be used prolong flower life and appearance and also kill or prevent infestation by pathogens or pests, repel pests, kill fungi, molds, bacteria and viruses, and control invasive species.

The term “plant” is used in a generic sense herein, and includes, for example, woody-stemmed plants such as trees and shrubs; herbs; vegetables, fruits, agricultural crops, and ornamental plants. Plants to be treated by the methods described herein include whole plants and any portions thereof, such as field crops, potted plants, seeds, cut flowers (stems and flowers), and harvested fruits and vegetables.

Plants which may be treated by the methods of the present invention to inhibit abscission of foliage, flowers and fruit include cotton (Gossypium spp.), apples, pears, cherries (Prunus avium), pecans (Carva illinoensis), grapes (Vitis vinifera), olives (e.g., Olea europaea), coffee (Cofffea arabica), snapbeans (Phaseolus vulgaris), and weeping fig (Ficus benjamina), as well as dormant seedlings such as various fruit trees including apple, ornamental plants, shrubbery, and tree seedlings. The methods and compositions disclosed herein and described, can be used to inhibit abscission of foliage, flowers and fruit and also kill or prevent infestation by pathogens or pests, repel pests, kill fungi, molds, bacteria and viruses, and control invasive species.

In addition, shrubbery which may be treated according to the present invention to inhibit abscission of foliage include privet (Ligustrum sp.), photinea (Photinia sp.), holly (Ilex sp.) ferns of the family Polypodiaceae, schefflera (Schefflera sp.), aglaonema (Aglaonema sp.), cotoneaster (Cotoneaster sp.), barberry (Berberis sp.), waxmyrtle (Myrica sp.) abelia (Abelia sp.), acacia (Acacia sp.) and bromeliades of the family Bromeliaceae.

The present disclosure provides for, and includes, providing DHP gas to an enclosed environment to prevent abscission with flowers such as roses, orchids, tulips, daffodils, hyacinths, carnations, chrysanthemums, baby's breath, daisies, gladiolus, agapanthus, anthuria, Protea, Heliconia, Strilitzia, lilies, asters, irises, delphiniums, liatris, lisianthus, statis, stephanotis, freesoa, dendrobiums, sunflowers, snap dragons. Also provided for and included is providing DHP gas to an enclosed environment to prevent abscission of cut ornamental foliage of roses, tulips, carnations, and mums, but other flowers such as gladiolus, baby's breath, daisies, orchids, lilies, iris, and snapdragons. The methods and compositions disclosed herein and described, can be used to inhibit abscission and also kill or prevent infestation by pathogens or pests, repel pests, kill fungi, molds, bacteria and viruses, and control invasive species.

The present disclosure provides for, and includes, providing DHP gas to an enclosed environment to extend the lifespan of cut flower species including but not limited to Rosa sp., Dianthus sp., Gerbera sp., Chrysanthemum sp., Dendranthema sp., lily, Gypsophila sp., Torenia sp., Petunia sp., orchid, Cymbidium sp., Dendrobium sp., Phalaenopsis sp., Cyclamen sp., Begonia sp., Iris sp., Alstroemeria sp., Anthurium sp., Catharanthus sp., Dracaena sp., Erica sp., Ficus sp., Freesia sp., Fuchsia sp., Geranium sp., Gladiolus sp., Helianthus sp., Hyacinth sp., Hypericum sp., Impatiens sp., Iris sp., Chamelaucium sp., Kalanchoe sp., Lisianthus sp., Lobelia sp., Narcissus sp., Nierembergia sp., Ornithoglaum sp., Osteospermum sp., Paeonia sp., Pelargonium sp., Plumbago sp., Primrose sp., Ruscus sp., Saintpaulia sp., Solidago sp., Spathiphyllum sp., Tulip sp., Verbena sp., Viola sp., and Zantedeschia sp.

The present disclosure further provides for, and includes, methods for producing ornamental plants comprising harvesting an ornamental plant, providing DHP gas at a final concentration in the range of 0.3 to 10 parts per million (ppm) to an enclosed environment containing said harvested ornamental plant; and maintaining the DHP gas at a final concentration in the range of 0.3 to 10 parts per million (ppm) in the enclosed environment containing the harvested ornamental plant. The disclosure further provides for, and includes, a storage container providing an enclosed environment comprising a harvested ornamental plant and DHP gas at a final concentration in the range of 0.3 to 10 parts per million (ppm).

In aspects according the present disclosure, the DHP gas is provided to the enclosed environment containing an agricultural product at a final concentration of at least 0.05 ppm for a period of time. DHP gas containing environments provide for a variety of benefits and methods including the destruction of ethylene, for example to inhibit the ripening process. DHP gas according to the present disclosure can be used to kill or prevent infestation by pathogens or pests, repel pests, kill fungi, molds, bacteria and viruses, and control invasive species. Other methods of using DHP gas to decrease ethylene and its effect on agricultural products are provided at paragraph [0047] above. In certain aspects, the DHP gas level can be up to 10 ppm. As provided herein, the DHP gas level ranges between 0.05 and 10 ppm.

In aspects according the present disclosure, the DHP gas is provided to the enclosed environment containing an agricultural product at a final concentration of at least 0.1 ppm. In another aspect, the DHP gas is provided and maintained at a concentration of at least 0.2 ppm. In a further aspect, the DHP gas is provided and maintained at a concentration of at least 0.3 ppm. In a further aspect, the DHP gas is provided and maintained at a concentration of at least 0.4 ppm. In a further aspect, the DHP gas is provided and maintained at a concentration of at least 0.5 ppm, at least 0.6 ppm, at least 0.7 ppm, at least 0.8 ppm, or at least 0.9 ppm. In one aspect, the DHP gas is provided and maintained at less than 1.0 ppm. In one aspect, the DHP gas is provided and maintained between 0.1 and 0.6 ppm. In another aspect, the DHP gas is provided and maintained between 0.4 and 1.0 ppm. In some aspects, the final DHP gas concentration in said environment is at least 0.1 ppm. In other aspects, the final DHP gas concentration in said environment is at least 0.2 ppm, least 0.4 ppm, least 0.6 ppm, or least 0.8 ppm. In one aspect, the final DHP gas concentration in said environment is less than 1.0 ppm. Persons of ordinary skill in the art may readily determine a preferred level of PHPG in view of the current disclosure and further in view of the type, number, and age of the agricultural product as discussed below.

In certain aspects, the method includes providing DHP gas at up to 10 ppm. In certain aspects, the method includes providing DHP gas at least at between 0.05 and 10 ppm. In one aspect, the method includes providing DHP gas at least at 0.08 ppm. In another aspect, the method includes providing DHP gas at least at 1.0 ppm. In yet another aspect, the method includes providing DHP gas at least at 1.5 ppm. In one aspect, the method includes providing DHP gas at least at 2.0 ppm. In another aspect, the method includes providing DHP gas at least at 3.0 ppm. In one aspect, the method includes providing DHP gas at least at 5.0 ppm. In another aspect, the method includes providing DHP gas at least at 6.0 ppm. In one aspect, the concentration of DHP gas provided is less than 10 ppm. In one aspect, the concentration of DHP gas provided is less than 9.0 ppm. In another aspect, the concentration of DHP gas provided is less than 8.0 ppm. In an aspect, the concentration of DHP gas provided is less than 7.0 ppm. In another aspect, the concentration of DHP gas provided is between 0.05 ppm and 10.0 ppm. In yet another aspect, the concentration of DHP gas provided is between 0.05 ppm and 5.0 ppm. In one aspect, the concentration of DHP gas provided is between 0.08 ppm and 2.0 ppm. In yet another aspect, the concentration of DHP gas provided is between 1.0 ppm and 3.0 ppm. In one aspect, the concentration of DHP gas provided in a clean room of the present disclosure is between 1.0 ppm and 8.0 ppm, or between 5.0 ppm and 10.0 ppm. In other aspects, the concentration of DHP gas provided in a clean room cycles between higher and lower concentrations of DHP gas. By way of non-limiting example, the DHP gas may be provided at a higher concentration during the overnight hours and a lower concentration during the daytime hours.

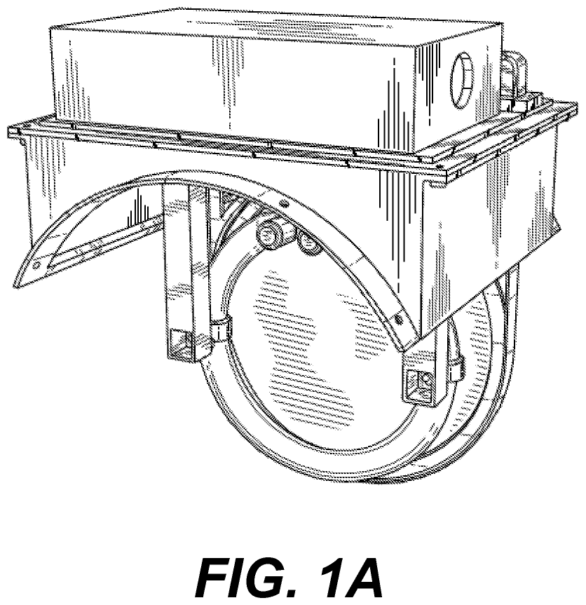

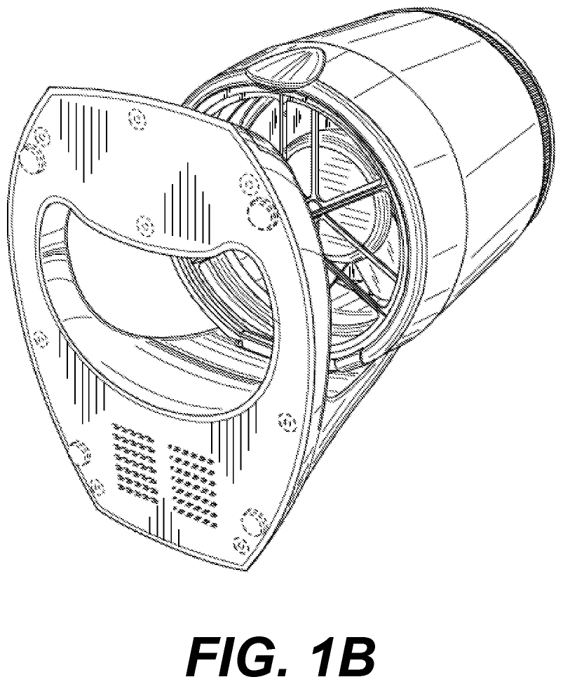

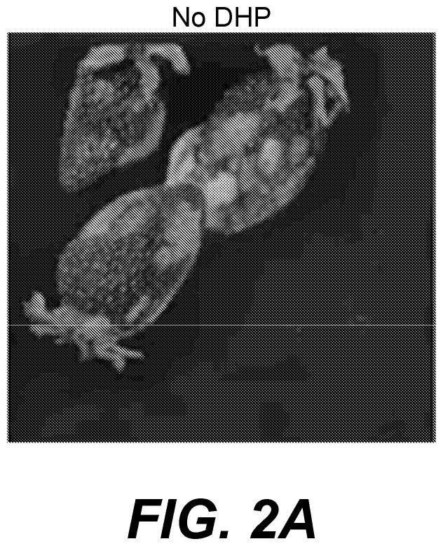

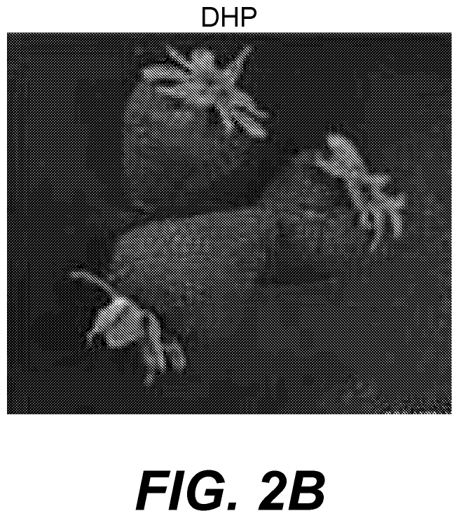

The present disclosure provides for, and includes, enclosed environments that comprise DHP gas and methods of using DHP gas provided by one or more PHPG producing devices. Suitable PHPG producing devices are known in the art and are disclosed in U.S. Pat. No. 8,168,122 issued May 1, 2012 and U.S. Pat. No. 8,685,329 issued Apr. 1, 2014. It will be appreciated, that the number and capacity of the PHPG producing devices necessary to achieve a concentration of at least 0.05 ppm DHP gas depends on the size of the enclosed environment. Exemplary devices are illustrated in FIGS. 1 and 2.

In some aspects, an entire greenhouse, or building, is an enclosed environment according to the present disclosure and the number of PHPG producing devices can be adjusted appropriately. In practice it has been determined that a single PHPG device can continuously maintain a space of about 425 m³ (about 15,000 ft³) at about 0.6 ppm. A suitable number of devices can provide an enclosed environment with up to 10 ppm H₂O₂. Notably, the enclosed environment does not need to be airtight or even isolated from the outside environment. In aspects according the present disclosure, the enclosed environments have active entrances and exits.

As provided herein, suitable PHPG producing devices can comprise an enclosure, an air distribution mechanism, a source of ultraviolet light, and an air-permeable substrate structure having a catalyst on its surface wherein a humid airflow passes through the air-permeable substrate structure and directs the PHPG produced by the device out of the enclosure when the device is in operation. As used herein, an enclosure and air distribution system can be the ductwork, fans, filters and other parts of an HVAC system suitable for an enclosed environment. In certain aspects, the PHPG device is provided after air filtration to maximize the production of PHPG and reduce losses of PHPG as the air moves through the system. In other aspects, a PHPG producing device may be a stand-alone device. In certain aspects, the PHPG generating device is capable of producing PHPG at a rate sufficient to establish a steady state concentration of PHPG of at least 0.005 ppm in a closed air volume of 10 cubic meters. In certain aspects, a PHPG generating device generates PHPG from water present in the ambient air. As used herein, the air distribution provides an airflow having a velocity from about 5 nanometers/second (nm/s) to 10,000 nm/s as measured at the surface of the air permeable substrate structure. As used herein, the substrate structure is an air permeable substrate structure having a catalyst on the surface configured to produce non-hydrated PHPG when exposed to a light source and provided an airflow. As used herein, the air permeable substrate structure having a catalyst on its surface is between about 5 nanometers (nm) and about 750 nm in total thickness. As used herein, the catalyst on the surface of an air permeable substrate structure is a metal, a metal oxide, or mixtures thereof and may be tungsten oxide or a mixture of tungsten oxide with another metal or metal oxide catalyst.

As provided herein, PHPG generating devices that can be installed into existing HVAC systems (e.g., inline) or as stand alone units produce PHPG that is essentially free of ozone, plasma species, or organic species. As used herein, the term “substantially free of ozone” means an amount of ozone below about 0.015 ppm ozone. In an aspect, “substantially free of ozone” means that the amount of ozone produced by the device is below or near the level of detection (LOD) using conventional detection means. Such levels are below the generally accepted limits for human health. In this regard, the Food and Drug Administration (FDA) requires ozone output of indoor medical devices to be no more than 0.05 ppm of ozone. The Occupational Safety and Health Administration (OSHA) requires that workers not be exposed to an average concentration of more than 0.10 ppm of ozone for 8 hours. The National Institute of Occupational Safety and Health (NIOSH) recommends an upper limit of 0.10 ppm of ozone, not to be exceeded at any time. Environmental Protection Agency's (EPA's) National Ambient Air Quality Standard for ozone is a maximum 8 hour average outdoor concentration of 0.08 ppm. The diffuser devices have consistently demonstrated that they do not produce ozone at levels detectable by means of a Draeger Tube.

As used herein, substantially free of hydration means that the hydrogen peroxide gas is at least 99% free of water molecules bonded by electrostatic attraction and London Forces. Also as used herein, a PHPG that is substantially free of plasma species means hydrogen peroxide gas that is at least 99% free of hydroxide ion, hydroxide radical, hydronium ion, and hydrogen radical. As used herein, PHPG is essentially free of organic species.

As described herein, in certain aspects of the disclosure, hydrogen peroxide is produced as a near-ideal gas phase, PHPG. In this form hydrogen peroxide behaves, in all respects, as a near-ideal gas and is not hydrated, or otherwise combined with water when produced. In this form, near-ideal gas phase hydrogen peroxide can penetrate to any space that can be reached by air itself This includes all areas in which contaminants such as microbes and organic compounds are present in a room, such as crevices between materials, inside air-permeable fabrics, air permeable walls, ceilings, floors, and in equipment. However, without being limited by theory, it should be noted that methods and devices of the present disclosure are not achieved as a result of the photocatalytic process, but by the effects of near-ideal gas PHPG once it is released into the environment.

Continuously produced via a PHPG diffuser device, as discussed herein, an equilibrium concentration above 0.05 parts per million of near-ideal gas phase hydrogen peroxide may be achieved and maintained continuously in an environment. At equilibrium at one atmosphere pressure and 19.51° C., near-ideal gas phase hydrogen peroxide will be present in every cubic micron of air at an average amount of one molecule per cubic micron for each 0.04 parts per million of concentration. At one part per million, the average number of hydrogen peroxide molecules per cubic micron will be 25, and at 3.2 parts per million it will be 80.

Not to be limited by theory, near-ideal gas phase hydrogen peroxide will be disseminated throughout the volume of the environment, including any air accessible space. The result of continuous exposure to near-ideal gas phase hydrogen peroxide at even low concentrations continuously kills or suppresses the growth of microorganisms including bacteria, viruses, molds and repels or kills insects and arachnids. Most arthropods, including insects do not have lungs, but survive solely by distributing oxygen through the body by means of a network of tracheal tubes. By this means near-ideal gas phase hydrogen peroxide reaches every portion of an arthropod's body and causes death to the arthropod, such as an insect. Not to be limited by theory the near-ideal gas phase hydrogen peroxide damages their air exchange tissues.

The present disclosure provides for, and includes, installing PHPG generating devices on portable enclosures, including but not limited to, storage containers, trucks, railcars, ships and planes that may be used according the present methods and compositions. Enclosed environments having suitable HVAC systems that further comprise one or more PHPG generating devices are sufficient to maintain the clean room at a concentration of 0.05 ppm DHP gas (e.g., inline PHPG generating devices).

The present disclosure provides for, and includes, methods and compositions to preserve an agricultural product. In the course of development, it was observed that agricultural products could be air dried and preserved. More specifically, because the present disclosure provided methods of preventing the growth of molds and preventing decay, when the agricultural product is stored under conditions of low humidity, it was observed to become dehydrated or dried. Accordingly, the present disclosure provides for methods of preserving agricultural products by placing an agricultural product in an enclosed environment having DHP gas at a concentration of at least 0.05 parts per million (ppm) and having a RH of less than 65%, and maintaining the agricultural product in the enclosed environment until the water content of said agricultural product is reduced. In certain aspects, the agricultural product is dried and preserved when the water content of the agricultural product was about 25% or less. In other aspects, the agricultural product is dried and preserved when the water content is 20% or less. In yet other aspects, the agricultural product is dried and preserved when the water content is 15% or less. Suitable levels of DHP gas for an enclosed environment for preserving and drying an agricultural product are provided above, for example at paragraphs [0099] to [00101].

The rate of preservation by air drying as provided herein depends on the RH. As provided, the RH should be less than 65%. In other aspects, the RH is less than 50%. In some aspects, the RH is less than 40% or less than 30%. In yet other aspect, the RH may be 20% or even 10% or less. One of skill in the art would recognize that the rate of drying is important and that if the rate is too fast (e.g., RH is too low) case hardening may occur wherein the outside layer of the fruit dries too quickly, becomes hard and prevents more moisture from being lost. Persons of ordinary skill in the art can determine appropriate humidity to minimize and avoid case hardening.

The present disclosure provides for air dried preserved agricultural products selected from the group consisting of green bean, broccoli, savoy cabbage, white cabbage, carrot, celery, cilantro, corn, dill weed, garlic, kale, leek, mushroom, onion, parsley, peas, pepper, potato, pumpkin, shallot, spinach, squash, tomato, zucchini, apple, apricots, bananas, blueberries, cranberries, gooseberry, huckleberry, raspberry, black mulberry, strawberry, cherry, date, fig, grape, kiwi, kumquat, mango, nectarine, peach, papaya, pear, persimmon, pineapple, plum and prune. In an aspect, the air dried preserved agricultural product is a strawberry. Other suitable agricultural products for drying and preserving are provided above at paragraphs [0074] and [0075]. As provided herein, suitable agricultural products for drying and preserving may be whole, chopped, sliced, cubed, or powdered.

The present disclosure further provides for, and includes, pretreating an agricultural product prior to placing the product into an enclosed environment for drying. In certain aspects, the pretreatment is to prevent darkening and discoloration. In other aspects, pretreating provides additional sugar and sweetness to the dried agricultural product. Suitable pretreatments are known in the art. In an aspect, the pretreatment is sulfuring. In another aspect the pretreatment is a treatment with sulfite, for example as a sulfite dip. In another aspect, an ascorbic acid solution is used as a pretreatment. In yet another aspect, the pretreatment is a fruit juice dip. In certain aspects, the fruit juice dip comprises a citrus fruit. In an aspect, the fruit juice is a lemon, orange, pineapple, grape or cranberry juice. Also provided is a pretreatment comprising dipping the agricultural product in honey before drying. In another aspect, the agricultural product can be syrup blanched. In another aspect, the agricultural product can be steam blanched as a pretreatment prior to drying.

The present disclosure further provides for, and includes, conditioning the dried agricultural product prior to storage. As will be understood by a person of skill in the art, conditioning comprises storing a plurality of agricultural products together in a sealed environment to allow for the equal distribution of the moisture. Not to be limited by theory, it is thought that the moisture content in a dried agricultural product, such as dried fruit for example, can vary among the individual items depending on the initial moisture content, the location in the drying environment, presence of skin, differences in size, or other reasons. Accordingly, before packaging and storage, the agricultural product is provided time for the moisture content to equilibrate among the plurality.

The present disclosure provides for, and includes, methods and compositions to preserve an agricultural product by drying provides for reduced levels of molds, fungi, bacteria and viruses as recited below at paragraphs [00140] to [00168]. Accordingly, dried agricultural products according to the present disclosure have reduced levels of bacteria, viruses and fungi. In certain aspects, the dried agricultural products have reduced levels of bacteria, viruses and fungi and are organic products.

The present disclosure further provides for, and includes, methods for producing an agricultural product comprising harvesting the agricultural product, storing the agricultural product in an enclosed environment in a relative humidity of less than 40% and more than 10% and in the presence of DHP gas at a final concentration in the range of 0.3 to 10 parts per million (ppm). The disclosure further provides for, and includes, a storage container providing an enclosed environment comprising a harvested agricultural product, a relative humidity of less than 40% and more than 10% and DHP gas at a final concentration in the range of 0.3 to 10 parts per million (ppm).

The present disclosure further provides for, and includes, methods and compositions for inhibiting the an ethylene response of an agricultural product comprising providing DHP gas at a final concentration of at least 0.05 ppm to an enclosed environment and further providing a cyclopropene or cyclopropene derivative. As used herein, a cyclopropene or cyclopropene derivative has the structure shown in FIG. 1:

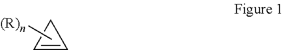

wherein wherein n is a number from 1 to 4 and R is selected from the group consisting of hydrogen, saturated or unsaturated C₁ to C₄ alkyl, hydroxy, halogen, C₁ to C₄ alkoxy, amino and carboxy. In an aspect, the cyclopropene derivative is 1-methylcyclopropene. In another aspect the cyclopropene derivative is dimethylcyclopropene.

The present disclosure further provides for, and includes, methods for producing an agricultural product comprising harvesting the agricultural product, storing the agricultural product in an enclosed environment in the presence of DHP gas at a final concentration in the range of 0.3 to 10 parts per million (ppm) and in the presence of 1-methylcyclopropene and/or dimethylcyclopropene. The disclosure further provides for, and includes, a storage container providing an enclosed environment comprising a harvested agricultural product, DHP gas at a final concentration in the range of 0.3 to 10 parts per million (ppm) and 1-methylcyclopropene and/or dimethylcyclopropene.

As used herein, an “enclosed environment” is any bounded space that can be maintained at a steady state level of PHPG of at least 0.05 parts per million using one or more PHPG generating devices. Generally, a suitable enclosed environment is sufficiently bounded that the exchange of air with the area outside the enclosure is limited. For certain enclosed environments, the enclosed environment is suitable for human occupation as PHPG levels of up to 1 ppm pose no risk. In contrast, unbounded environments, such as a non-enclosed outdoor environment, can not attain a steady state level of PHPG of at least 0.05 parts per million because the PHPG generated will blow or diffuse away. As provided herein, an enclosed environment need only be sufficiently bounded to prevent the loss of PHPG at rate that is greater than the rate of production of one or more suitable PHPG generating devices. Accordingly, the presence of doors, windows, entrances, holes, cracks, screens and other openings does not mean that the space is not an enclosed space.

PHPG can be provided to an enclosed environment to inhibit ethylene response and prolong the freshness (e.g., delay ripening, abscission, senescence). PHPG can be provided to an enclosed environment to inhibit the ethylene response delay or prevent ripening, senescence, abscission, provide growth inhibition, provide growth stimulation, promote or inhibit branching, tillering, seed development, flower development, seed germination, and breaking of seed dormancy. PHPG can also be provided to an enclosed environment to kill or prevent infestation by pathogens or pests, repel pests, kill fungi, molds, bacteria and viruses, and control invasive species.

The present disclosure provides for an enclosed environment selected from the group consisting of storage container, a shipping container, a vehicle, a distribution center, a storage facility, a wholesale center, a CEA facility, a greenhouse, a cold frame, a hoop house, a retail store, a kitchen, a restaurant, a flower shop, a barn, a food processing area, a market storage area, and a market display area.

The present disclosure provides for, and includes, a CEA facility having DHP gas at a concentration of at least 0.05 parts per million (ppm). Suitable CEA facilities include greenhouses, and hydroponics, and aquaponics facilities.

The present disclosure provides for, and includes, shipping containers, also known as standard intermodal freight containers, having at least 0.05 ppm of DHP gas. In certain aspects, the DHP gas level can be up to 10 ppm. In certain aspects, the DHP gas level ranges between 0.05 and 10 ppm. Additional suitable levels of DHP gas are provided, for example at paragraphs [0099] to [00101].

As provide herein, a shipping container includes corrugated boxes, wooden boxes, crates, intermediate bulk containers (IBCs), Flexible Intermediate Bulk Containers (FIBCs), bulk boxes, drums, insulated shipping containers, and unit load devices. As provided herein, the shipping containers according to the present disclosure may further comprise one or more integrated PHGP generating devices, or may be supplied with DHP gas by being placed in an enclosed space (e.g., in the hold of a ship or plane having DHP gas at a concentration of at least 0.05 ppm). In certain aspects, the shipping container comprises a PHGP generating device and may further comprise chilling and heating units as appropriate. Shipping containers suitable for the compositions and methods of the present disclosure include, but are not limited to, shipping containers that comply with one or more of the following international standards: ISO 6346:1995, ISO 668:2013, ISO 1161:1984, and ISO 1496-1:2013.

The present disclosure provides for, and includes, methods for inhibiting the ripening process of an agricultural product during shipping comprising providing an enclosure for shipping an agricultural product, placing an agricultural product in the enclosure, providing DHP gas at a concentration of at least 0.05 parts per million (ppm) to the enclosure; and maintaining the DHP gas concentration during shipping.

According to aspects of the present disclosure, ripening is inhibited during shipping and delays the time to peak ripeness. The present disclosure provides for, and includes, a method for inhibiting the ripening process of an agricultural product during shipping comprising providing an enclosure for shipping an agricultural product, placing an agricultural product in the enclosure, providing DHP gas to the enclosure and maintaining the DHP gas concentration during said shipping. The method includes providing a concentration of DHP gas sufficient to delay peak ripeness by at least a day, at least 2 days, at least 3 days, at least 4 days, at least 5 days, at least 6 days, at least a week, or at least two weeks. DHP gas levels according the present disclosure for the inhibition of ripening and extending the time of peak ripeness are provided above at paragraphs [0099] to [00101].

In some aspects, the agricultural product for shipping under conditions for inhibition of ripening by DHP gas is a fruit. In other aspects, the agricultural product is a vegetable. In other aspects, the agricultural product is a nut, a seed, grain, or tuber. In an aspect the grain is selected from the group consisting of rice, wheat, corn, and barley. In some aspects, shipping containers are built to international standard making them interchangeable between shipping companies, rail and truck companies. In yet other aspects, the DHP gas containing shipping containers may be optionally refrigerated, or otherwise treated as is standard during shipping. In another aspect the agricultural product is a perishable product. In certain aspects, the agricultural product is shipped in an environment having DHP gas to minimize or avoid the transport and introduction of foreign species.

The present disclosure provides for, and includes, methods and compositions for controlling a pathogen in an agricultural product during shipping comprising providing DHP gas at a concentration of at least 0.05 parts per million (ppm) to a shipping container containing an agricultural product to prepare a DHP gas containing shipping container, shipping the DHP gas containing shipping container; and maintaining the DHP gas concentration during shipping thereby controlling the pathogens. The present disclosure provides for DHP gas levels of up to 10 ppm and as further recited at paragraphs [0099] to [00101]. Pathogens controlled according the present disclosure include, but are not limited to the pathogens recited below beginning at paragraph [00140].

The present disclosure provides for, and includes, a method for controlling the ripening process of an agricultural product in a storage facility. Storage facilities according to the present disclosure include personal and industrial storage facilities. In an aspect, the storage facility may be selected from the group consisting of a silo, a drum, a bin, a container, a cooler, a refrigerator, and a bag. The method includes providing a concentration of DHP gas sufficient to delay peak ripeness by at least a day, at least 2 days, at least 3 days, at least 4 days, at least 5 days, at least 6 days, at least a week, or at least two weeks. In certain aspects, the DHP gas is provided continuously to the storage facility. In other aspects, the DHP gas is provided intermittently to the storage facility. In an aspect, the DHP gas is provided during the daytime. In another aspect, the DHP gas is provided during the overnight hours.

In aspects according the present disclosure, the DHP gas for controlling ripening in a storage facility is provided at a final concentration to a storage facility of at least 0.05 ppm up to 10 ppm. In another aspect, the DHP gas concentration is provided and maintained at a concentration of at least 0.2 ppm. In a further aspect, the DHP gas concentration is provided and maintained at a concentration of at least 0.3 ppm. In a further aspect, the DHP gas concentration is provided and maintained at a concentration of at least 0.4 ppm. In a further aspect, the DHP gas concentration is provided and maintained at a concentration of at least 0.5 ppm, at least 0.6 ppm, at least 0.7 ppm, at least 0.8 ppm, or at least 0.9 ppm. In one aspect, the DHP gas concentration is provided and maintained at less than 1.0 ppm. In one aspect, the DHP gas concentration is provided and maintained between 0.1 and 0.6 ppm. In another aspect, the DHP gas concentration is provided and maintained between 0.4 and 1.0 ppm. Persons of ordinary skill in the art may readily determine a preferred level of DHP gas in view of the current disclosure and further in view of the type, number, and source of the agricultural product. DHP gas levels according the present disclosure for controlling ripening in a storage facility are provided above at paragraphs [0099] to [00101].

The present disclosure provides for and includes, methods and composition wherein the DHP gas concentration is maintained for a period of time. In certain, aspects, the enclosed environment is maintained having a DHP gas concentration of at least 0.05 ppm for an indefinite period of time. In other aspect, the enclosed environment is maintained at a DHP gas concentration of up to 10 ppm. Maintaining the DHP gas level provides for continuous DHP gas activity against microorganisms and arthropods, thus during shipping surfaces of the agricultural products become progressively reduced microorganisms load and arthropods are killed or repelled.

DHP gas is very effective at reducing the levels of various microorganisms and arthropods. As provided below at Example 2, Table 1, the H1N1 virus can be reduced by 90% in less than 30 minutes. The pathogenic bacteria MRSA is reduced by 90% in under 5 hours. The vegetative form of the fungus Aspergillus niger can be reduced by 90% in 7 hours when present on an agricultural product, for example a strawberry. As will be understood by one of ordinary skill in the art, even a brief treatment of less than an hour results in a decrease in the number of pathogens or microorganisms. Similarly, DHP gas has immediate effect against VOCs, for example ethylene as well, though the effect on an ethylene mediated activity depends on the continued application of DHP gas. As provided herein, it is anticipated that agricultural products will be maintained in the DHP gas containing environment for extended periods of time for example during storage and shipment.

The present disclosure provides for, and includes, treating an agricultural product for at least 15 minutes. In other aspects, the DHP gas is provided for at least 1 hour. In certain aspects, the DHP gas is provided for at least 2 hours. In additional aspects, the DHP gas is provided for at least 3 or 4 hours. In certain aspects, the agricultural product is exposed to an enclosed environment having DHP gas for at least 6 hours or even 12 hours. Other aspects provide for exposure of at least 24 hours.

Also provided and included in the present disclosure is the application of DHP gas to agricultural products for one or more weeks. In other aspects, DHP gas can be provided to the enclosed environment for a month or more. Also included are methods and compositions wherein DHP gas is provided continuously, for example during shipping or storage. Notably, given the safety and efficacy of DHP gas, enclosed environments having DHP gas are safe for human habitation, therefore, workers may enter and exit the DHP gas containing environment to add and remove agricultural products. Similarly, customers may enter to examine and purchase agricultural products in the DHP gas containing environments according to the present disclosure.

The present disclosure further provides for, and includes, methods for producing an agricultural product comprising harvesting the agricultural product, storing the agricultural product in an enclosed environment in the presence of DHP gas at a final concentration in the range of 0.3 to 10 parts per million (ppm) for a time period of 15 minutes to 24 hours.

The present disclosure provides for, and includes, a method for reducing the concentration of a VOC in an enclosed environment comprising providing PHPG to an environment at a concentration of at least 0.05 ppm for a period of time, wherein the VOC is reduced by oxidation. The present disclosure includes and provides for a method for reducing the concentration of a VOC in an enclosed environment comprising providing PHPG to an environment at a concentration of at least 10 ppm for a period of time, wherein the VOC is reduced by oxidation. In aspects according to the present disclosure, the VOC is selected from the group consisting of a hydrocarbon, an alcohol, an ester, an ether, an aldehyde, a ketone, an alkyl-halide, an amine, and combinations thereof. DHP gas levels according the present disclosure for reducing the concentration of a VOC in an enclosed environment are provided above at paragraphs [0099] to [00101].

During production of certain agricultural products, various organic compounds are applied, for example pesticides and fungicides. Like VOCs, these compounds have a variety of chemical groups that are oxidizable by PHPG. Accordingly, PHPG treatment of an agricultural product results in reductions of these often undesirable organic compounds. The present methods are an improvement over prior art methods in that the products do not need washing and the treatment is safe. As such, there are no concerns that workers would be exposed to any hazardous conditions.

In certain aspects, treated agricultural products will have reduced levels of pesticides, fungicides, insecticides and other organic residues. In certain aspects, the organic residues will be reduced by at least 10% or at least 20%. In other aspects, the organic residue will be reduced by at least 30%. In another aspect, the organic residue will be reduced by at least 40%. In another aspect, the organic residue will be reduced by at least 50%. In another aspect, the organic residue will be reduced by at least 60% or at least 70%. The present disclosure provides for reductions in organic residues of pesticides, fungicides, insecticides and the like by 80% or more. In certain aspects, organic residues are reduced by 90% or 95%. In some aspects, up to 99% of organic residues of pesticides, fungicides, insecticides and the like can be eliminated. As used herein, elimination of an organic residue refers to the oxidation of the residue to a simpler compound by H₂O₂.

The present disclosure provides for, and includes, methods for controlling an infestation of a pathogen on an agricultural product comprising providing DHP gas at a final concentration of at least 0.05 parts per million (ppm) to an enclosed environment containing said infested agricultural product; and maintaining said DHP gas at a final concentration of at least 0.05 parts per million (ppm) in said enclosed environment for a time period sufficient to control said pathogen. The present disclosure also includes methods for controlling an infestation of a pathogen on an agricultural product comprising providing DHP gas at a final concentration of at least 10 ppm. DHP gas levels according the present disclosure for controlling an infestation of a pathogen on a plant or plant product are provided above at paragraphs [0099] to [00101].

In aspects according the present disclosure, methods for controlling an infestation of a pathogen on an agricultural product wherein the plant or plant product includes plant products selected from the group consisting of a fruit, a vegetable, a seed, a root, a leaf, and a flower. Suitable enclosed environments for controlling an infestation of a pathogen on a plant or plant product are provided above at paragraphs [00120] to [00123]. Suitable enclosed environments for controlling an infestation of a pathogen on a plant or plant product include shipping containers as provided at paragraphs [00124] and [00125] and storage containers as provided at paragraph [00130].

The present disclosure provides for, and includes, methods for controlling an infestation of a pathogen on a plant or plant product wherein the pathogen is a virus, a viroid, a virus-like organism, a bacterium, a phytoplasma, a protozoa, an algae, a nematode, a parasite, an insect, an arachnid, an oomycete, a fungus, or a mold. As used herein, controlling a pathogen includes cessation of all activity, reduction in pathogenicity, reduction in virulence, reduction in transmission, reduction in reproduction, reduction in amount, preventing an infestation, and elimination.

In various aspects, the pathogen may be selected from the group consisting of fungus, archaea, protest, protozoa, bacterium, bacterial spore, bacterial endospore, virus, viral vector, and combinations thereof. In other aspects, the microorganism may be selected from the group consisting of Naegleria fowleri, Coccidioides immitis, Bacillus anthraces, Haemophilus influenzae, Listeria monocytogenes, Neisseria meningitides, Staphylococcus aureus, Streptococcus pneumoniae, Streptococcus agalactiae, Pseudomonas aeruginosa, Yersinia pestis, Clostridium botulinum, Francisella tularensis, variola major, Nipah virus, Hanta virus, Pichinde virus, Crimean-Congo hemorrhagic fever virus, Ebola virus, Marburg virus, Lassa virus, Junin virus, human immunodeficiency virus (“HIV”), or SARS-associated coronavirus (“SARS-CoV”).

The methods of the present disclosure further provide for the reduction or elimination of pathogens selected from the group consisting of S. Aureus, Alcaligenes Xylosoxidans, Candida Parapsilosis, Pseudomonos Aeruginosa, Enterobacter, Pseudomonas Putida, Flavobacterium Meningosepticum, Pseudomonas Picketti, Citrobacter, and Corynebacteria. The present disclosure further includes methods to reduce or eliminate C. difficile, Chlamydia, hepatitis virus, non smallpox orthopoxvirudae, influenza, Lyme disease, Salmonella sp., mumps, measles, methicillin-resistant Staphylococcus aureus (MRSA), or vancomycin-resistant Staphylococcus aureus (VRSA). In additional aspects, the present disclosure provides for the reduction or elimination of Yersinia pestis, Francisella tularensis, Leishmania donovani, Mycobacterium tuberculosis, Chlamydia psittaci, Venezuelan equine encephalitis virus, Eastern equine encephalitis virus, SARS coronavirus, Coxiella burnetii, Rift Valley fever virus, Rickettsia rickettsia, Brucella sp., rabies virus, chikungunya, yellow fever virus, and West Nile virus.

The present disclosure provides for, and includes, methods and compositions for controlling an infestation of a pathogen on an agricultural product comprising providing PHPG at a final concentration of at least 0.05 parts per million (ppm) to an enclosed environment containing the agricultural product. In an aspect the method is a GRAS method for controlling an infestation of a pathogen on an agricultural product. The present disclosure also includes methods for controlling an infestation of a pathogen on an agricultural product comprising providing DHP gas at a final concentration of at least 10 ppm. Other suitable

DHP gas levels according the present disclosure for controlling an infestation of a pathogen on an agricultural product are provided above at paragraphs [0099] to [00101]. Agricultural products, include but are not limited to the agricultural products as recited at paragraphs [0074] and [0075].

By reducing the number of pathogens on an agricultural product, the present disclosure provides for agricultural products having reduced numbers of pathogens. The present disclosure provides for agricultural products that have not been irradiated or treated with a chemical. As H₂O₂ breaks down completely to water and oxygen, the methods and agricultural products are completely “green” and GRAS.

The present disclosure provides for, and includes, methods and compositions for controlling a pathogen in a CEA facility comprising providing DHP gas at a final concentration of at least 0.05 parts per million (ppm) to the CEA facility, and maintaining the DHP gas at a final concentration of at least 0.05 parts per million (ppm) for a time period sufficient to control the pathogen. Suitable CEA facilities include, but are not limited to greenhouses, hoop houses, cold frames, hydroponics, and aquaponics facilities. In certain aspects, the DHP gas is provided intermittently. In certain aspects, the DHP gas is provided to repel or kill pests such as insects and spiders. In other aspects, the DHP gas is provided continuously.

In an aspect, the present disclosure provides for an organic agricultural product having a reduced numbers of pathogenic organisms. In an aspect, the number of pathogenic organisms are reduced by at least 25%. In another aspect the pathogenic organisms are reduced by at least 50%. In a further aspect, the pathogenic organisms are reduced by at least 60%. In another aspect, the pathogenic organisms are reduced by at least 70%. In yet another aspect, the pathogenic organisms are reduced by at least 75%. In other aspects, the pathogenic organisms are reduced by at least 80%. The present disclosure provides for agricultural products having a reduction of pathogenic organisms of at least 90% relative to an untreated agricultural product. In certain aspect, the pathogenic organisms on an agricultural product are reduced by at least 95%. In some aspects, the pathogenic organisms are reduced by at least 99.9%. One of ordinary skill in the art would recognize that the degree of reduction is dependent on the amount of time the agricultural products are treated with DHP gas. Suitable times for treating agricultural products are recited above at paragraph [00132]. In particular aspects, the agricultural product is a vegetable as recited above at paragraphs [0078] to [0081]. In another particular aspect, the agricultural product is a fruit as recited at paragraphs [0083] to [0086].

The present disclosure provides for, and includes, methods and compositions for controlling an infestation of a pathogen on an agricultural product comprising providing PHPG at a final concentration of at least 0.05 parts per million (ppm) to an enclosed environment containing the agricultural product. In aspects according the present disclosure, the pathogen is a bacteria. In certain aspects the bacteria that are reduced are bacteria that are responsible for human disease and are transmitted via an agricultural product (for example certain E. coli transmitted and ingested via lettuce). In other aspects, the bacteria are responsible for spoilage of the agricultural product. Thus in certain aspects, a reduction in the number of bacteria results in a reduction of spoilage and an increase in the shelf life of an agricultural product. In certain aspects, the agricultural product is a vegetable or fruit as recited at paragraphs [0078] to [0081] and at paragraphs [0083] to [0086], respectively.

In an aspect, the bacteria are lactic acid bacteria such as Lactobacillus, Leuconostoc, Pediococcus, Lactococcus, and Enterococcus. In another aspect, the bacteria are gram negative. In yet another aspect, the bacteria are gram positive. In certain aspects, the bacteria are a member of the genera selected from the group consisting of Acetobacter, Gluconobacter, Aeromonas, Arthrobacter, Aureobacterium, Xanthomonas, Pseudomonas, Clostridium, Cytophaga, Corynebacterium, Enterobacter, Erwinia, Flavobacterium, Bacillus, Klebsiella, Serratia, Alcaligenes, and Pantoea. In another aspect, the bacteria may be Erwinia amylovora, Erwinia aphidicola, Erwinia billingiae, Erwinia mallotivora, Erwinia papayae, Erwinia persicina, Erwinia psidii, Erwinia pyrifoliae, Erwinia rhapontici, Erwinia toletana. Erwinia tracheiphila, Candidatus Erwinia dacicola. In another aspect, the bacteria may be Erwinia carotovora, Xanthomonas campestris, Penicillium expansum, Botrytis cinerea, Pseudomonas fluorescens, Pseudomonas viridiflava Pseudomonas tolaasii, Pseudomonas marginalis, Leuconostoc mesenteroides, Pantoea agglomerans Burkholderia cepacia Burkholderia cepacia Pantoea herbicola, P. marginalis and P. chlororaphis, Pseudomonas cichorii, P. syringae, P. viridiflava, or L. mesenteroides.

The present disclosure provides for, and includes, methods and compositions for reducing food borne illnesses comprising treating an agricultural product with DHP gas at a final concentration of at least 0.05 parts per million (ppm) to reduce the number of bacteria, viruses, and parasites present. The disclosure also provides for, and includes, methods and compositions for reducing food borne illnesses comprising treating an agricultural product with DHP gas at a final concentration of up to 10 parts per million (ppm) to reduce the number of bacteria, viruses, and parasites present on an agricultural product. In certain aspects, the agricultural product is a vegetable or fruit as recited at paragraphs [0078] to [0081] and at paragraphs [0083] to [0086] respectively. In certain aspects, the agricultural product is a raw agricultural product.

The disclosure provides for the reduction of bacterial pathogens on agricultural products, thereby decreasing the risk of food borne illnesses. In an aspect, the agricultural product is treated with DPH gas to reduce E. coli O157:H7. In an aspect, the bacterial pathogen is a Salmonella species. In another aspect, the bacterial pathogen is Clostridium perfringens. In yet another aspect, the bacterial pathogen is a Camplylobacter species. In a further aspect the bacterial pathogen is a Staphylococcus species. In an aspect the Staphylococcus species is Staphylococcus aureus.

Also included and provided for by the present disclosure, are methods and compositions for controlling an infestation of a pathogen on an agricultural product wherein the pathogen is a virus. In an aspect, the method provides for the elimination of a virus on an agricultural product, in other aspects, the virus is reduced relative to an untreated agricultural product. There are no known viruses of any type that are resistant to H₂O₂, whether provided as a gas, a liquid or a vapor. Importantly, viruses transmitted and ingested as agricultural products result in significant human illness and mortality.

Viral loads and active viruses may be reduced or eliminated on agricultural products when treated, shipped, or stored in an enclosed environment comprising DHP gas at a concentration of at least 0.05 ppm. The methods and compositions of the present disclosure are effective against all classes of viruses including class I viruses comprising double stranded DNA (dsDNA) viruses including for example adenoviruses, herpesviruses, and poxviruses; Class II viruses comprising single stranded DNA (ssDNA) viruses, for example parvoviruses; Class III double stranded RNA (dsRNA) viruses including for example reoviruses, Class IV viruses comprising plus strand single stranded ((+)ssRNA) viruses, for example picornaviruses and togaviruses; Class V viruses comprising minus strand single stranded RNA ((−)ssRNA) viruses, for example orthomyxoviruses and rhabdoviruses including Arenaviridae, Class VI virusus comprising single stranded RNA reverse transcribed (ssRNA-RT) viruses that have an RNA genome with DNA intermediate in life-cycle (e.g., retroviruses); and Class VII viruses comprising double stranded DNA reverse transcribed (dsDNA-RT) viruses (e.g. hepadnaviruses including hepatitis viruses). It is expected that H₂O₂ gas is effective at inactivating and killing all viruses. Resistant viruses are not known.

The present disclosure provides for methods and compositions effective against all Class I viruses including but not limited to the group selected from Herpesviridae (including herpesviruses, Varicella Zoster virus), Adenoviridae, Asfarviridae (including African swine fever virus), Polyomaviridae (including Simian virus 40, JC virus, BK virus), and Poxviridae (including cowpox virus, smallpox).

The present disclosure provides for methods and compositions effective against all Class III viruses including but not limited to Picobirnaviridae and Reoviridae (including Rotavirus).

The present disclosure provides for methods and compositions effective against all Class IV viruses including but not limited to the families selected from the group consisting of Coronaviridae (including coronavirus, SARS), Picornaviridae (including poliovirus, rhinovirus (a common cold virus), hepatitis A virus), Flaviviridae (including Yellow fever virus, West Nile virus, Hepatitis C virus, Dengue fever virus); Caliciviridae (including Norwalk virus also known as norovirus) and Togaviridae (including Rubella virus, Ross River virus, Sindbis virus, Chikungunya virus). The present disclosure provides for methods and compositions effective against norovirus.

The present disclosure provides for methods and compositions effective against all Class V viruses which includes nine virus families that comprise some of the most deadly viruses known. The methods of the present disclosure are effective at reducing or eliminating viruses of the families Arenaviridae, Bunyaviridae, Rhabdoviridae, Filoviridae, and Paramyxoviridae.

The present disclosure provides for methods and compositions effective against all retroviruses of Class VI including but not limited to the group selected from Alpharetrovirus, Betaretrovirus, Gammaretrovirus, Deltaretrovirus; Epsilonretrovirus, and Lentivirus. The methods and compositions of the present disclosure are also effect against the virus families Bornaviridae (includes Borna disease virus); Filoviridae (includes Ebola virus, Marburg virus); Paramyxoviridae (includes Measles virus, Mumps virus, Nipah virus, Hendra virus, RSV and NDV); Rhabdoviridae (includes Rabies virus); Nyamiviridae (includes Nyavirus);

Arenaviridae (includes Lassa virus); Bunyaviridae (includes Hantavirus, Crimean-Congo hemorrhagic fever); Ophioviridae (infects plants); and Orthomyxoviridae (includes Influenza viruses).

Also provided for and included in the present disclosure are agricultural products having reduced numbers of plaque forming units (PFU) of virus. As used herein, plaque forming units refers to the number of active (e.g., infective) viral particles. In certain aspects the agricultural product is not treated with radiation. In other aspects the agricultural product is not treated with a chemical. In yet other aspect, the agricultural product is not treated with either radiation or a chemical.

In an aspect, the present disclosure provides for an organic agricultural product having a reduced numbers PFU of virus. In an aspect, the number of PFUs are reduced by at least 25%. In another aspect the PFUs are reduced by at least 50%. In yet another aspect, the PFUs are reduced by at least 75%. The present disclosure provides for agricultural products having a reduction of PFUs of at least 90% relative to an untreated agricultural product. In particular aspects, the agricultural product is a vegetable as recited above at paragraphs [0078] to [0081]. In another particular aspect, the agricultural product is a fruit as recited at paragraphs [0083] to [0086].

Included and provided for by the present disclosure, are methods and composition for controlling an infestation of a pathogen on an agricultural product wherein the pathogen is a fungus. The fungi may be one or more of the following fungi: Botrytis cinerea, Botryodiplodia theobromae, Ceratocystis fimbriata, Fusarium spp., Rhizopus oryzae, Cochliobolus lunatus (Curvularia lunata), Macrophomina phaseolina, Sclerotium rolfsii, Rhizoctonia solani, and/or Plenodomus destruens. In another aspect, the fungi may belong to the genera Alternaria, Aspergillus, Botrytis, Cladosporium, Colletotrichum, Thamnidium, Phomopsis, Fusarium, Penicillium, Phoma, Phytophthora, Pythium, or Rhizopus. In another aspect, the fungi may be a species selected from the group consisting of Alternaria alternata, Aspergillus amstelodami, Aspergillus chevaliers, Aspergillus flavus, Aspergillus fumigatus, Aspergillus nidulans, Aspergillus niger, Aspergillus repens, Aspergillus terreus, Aspergillus ustus, Aspergillus versicolor, Aureobasidium pullulans, Chaetomium globosum, Cladosporium cladosporoïdes, Cladosporium herbarum, Botrytis cinerea, Ceratocystis fimbriata, Rhizoctonia solani, and Sclerotinia sclerotiorum.

Included and provided for by the present disclosure, are methods and compositions for controlling an infestation of a pathogen on an agricultural product wherein the pathogen is a fungus. The fungus may be one or more of the following: Penicillium, Phytophthora, Alternaria, Botrytis, Fusarium, Cladosporium, Phoma, Trichoderma, Aspergillus, Alternaria, Rhizopus, Aureobasidium, or Colletotrichum.

In aspects according the present disclosure, the controllingof an infestation of a pathogen provides for control of, and reduction of, spoilage by reducing the pathogen load on an agricultural product. In certain aspects, the spoilage may be reduced by reducing the number of spores of a fungus selected from the group consisting of Penicillium, Phytophthora, Alternaria, Botrytis, Fusarium, Cladosporium, Phoma, Trichoderma, Aspergillus, Alternaria, Rhizopus, Aureobasidium, and Colletotrichum.

Also provided for and included in the present disclosure are agricultural products having reduced numbers of spores of a fungus selected from the group consisting of Penicillium, Phytophthora, Alternaria, Botrytis, Fusarium, Cladosporium, Phoma, Trichoderma, Aspergillus, Alternaria, Rhizopus, Aureobasidium, and Colletotrichum. In certain aspects the agricultural product is not treated with radiation. In other aspects the agricultural product is not treated with a chemical. In yet other aspect, the agricultural product is not treated with either radiation or a chemical.

In an aspect, the present disclosure provides for an organic agricultural product having a reduced level of fungal spores selected from the group consisting of Penicillium, Phytophthora, Alternaria, Botrytis, Fusarium, Cladosporium, Phoma, Trichoderma, Aspergillus, Alternaria, Rhizopus, Aureobasidium, and Colletotrichum. In an aspect, the number of fungal spores are reduced by at least 25%. In another aspect the fungal spores are reduced by at least 50%. In yet another aspect, the fungal spores are reduced by at least 75%. The present disclosure provides for agricultural products having a reduction of fungal spores of at least 90% relative to an untreated agricultural product. In particular aspects, the agricultural product is a vegetable as recited above at paragraphs [0078] to [0081]. In another particular aspect, the agricultural product is a fruit as recited at paragraphs [0083] to [0086].

In certain aspects according the present disclosure, the fungus is a yeast selected from the group consisting of Candida spp., Cryptococcus albidus, Rhodotorula spp., Trichosporon penicillatum, and Saccharomyces cerevisiae. In certain aspects, the present disclosure provides for methods and compositions that provide for a reduction in the levels of yeasts of the genera Saccharomyces, Candida, Torulopsis, and Hansenula that have been associated with fermentation of fruits. In addition, other yeasts that can cause quality loss of produce include Rhodotorula mucilaginosa, R. glutinis, Zygosaccharomyces bailii, Z. bisporus, and Z. rouxii are reduced by the methods and compostions of the present disclosure.

In an aspect, the present disclosure provides for an organic agricultural product having reduced levels of yeast selected from the genera Saccharomyces, Candida, Torulopsis, and Hansenula. In another aspect, the present disclosure provides for an organic agricultural product having reduced levels of yeast selected from Rhodotorula mucilaginosa, R. glutinis, Zygosaccharomyces bailii, Z. bisporus, or Z. rouxii. In an aspect, the number of yeast are reduced by at least 25%. In another aspect the fungal spores are reduced by at least 50%. In yet another aspect, the yeast are reduced by at least 75%. The present disclosure provides for agricultural products having a reduction of yeast of at least 90% relative to an untreated agricultural product. In particular aspects, the agricultural product is a vegetable as recited above at paragraphs [0078] to [0081]. In another particular aspect, the agricultural product is a fruit as recited at paragraphs [0083] to [0086].

Increasingly, agricultural products are being shipped internationally and a growing concern is the presence of “stowaways” that can accompany shipments. These stowaways include the venomous banana spiders, which accompany their eponymous fruit, or the Mediterranean fruit fly. There are many insects and arachnids that are unwanted cohabitants on agricultural product shipments.

The present disclosure provides for, and includes, a method for controlling an arthropod in an agricultural product during shipping comprising providing PHPG to a shipping container containing an agricultural product to prepare a PHPG containing shipping container, shipping said container and maintaining said PHPG concentration at a predetermined concentration. In an aspect, the PHPG concentration is provided and maintained at a concentration of at least 0.05 parts per million (ppm). In one aspect, PHPG concentration is provided and maintained at a concentration of at least 10 ppm. Also included and provided for in the present disclosure are methods in which the PHPG is initially provided at concentration that is greater than the shipping concentration to provide enhanced initial killing of an arthropod. Using the methods below and those known in the art, determining the optimal amounts of PHPG during shipping may be accomplished with no more than routine experimentation. DHP gas levels according the present disclosure for controlling an arthropod in an agricultural product during shipping are provided above at paragraphs [0099] to [00101].

The present disclosure provides for, and includes, methods and compositions for protecting an agricultural product comprising providing DHP gas at a final concentration of at least 0.05 parts per million (ppm) to an enclosed environment suitable, and maintaining the DHP gas at a final concentration of at least 0.05 parts per million (ppm). In some aspects, the DHP gas is provided at concentration of up to 10 ppm. As provided herein, protection of an agricultural product includes protection from the pathogens as recited above as well as arthropod pests. Enclosed environments protectable by DHP gas include an enclosed environment suitable for growing an agricultural product, including but not limited to a greenhouse, a hoop house, a cold frame, a hydroponic environment, or an aeroponic environment. Included and provided for are agricultural products, such as those recited above at paragraphs [0078] to [0086].

In aspects according the present disclosure, the DHP gas provides protection by preventing or inhibiting contamination of said agricultural product growing in said enclosed environment by a virus or bacterium, including those recited above. In another aspect, the DHP gas provides protection by preventing or inhibiting damage and losses due to parasitic fungi on the agricultural product growing in the enclosed environment. In another aspect, the DHP gas provides protection by preventing or inhibiting damage and losses due to parasitic fungi on the nutrient bed in which said agricultural product grows in said enclosed environment. In other aspects, the DHP gas provides protection by preventing or inhibiting damage due to insect or arachnid activity on said agricultural product growing in said enclosed environment. In some aspects, the DHP gas provides protection by discouraging entry of an insect or arachnid into said enclosed environment that further comprises an agricultural product growing in said enclosed environment. In another aspect, the DHP gas provides protection by driving insects or arachnids out of said enclosed environment that further comprises an agricultural product growing in said enclosed environment. In yet another aspect, the DHP gas provides protection by causing an insect or arachnid in said enclosed environment that further comprises an agricultural product growing in said enclosed environment to go dormant and die. In a further aspect, the DHP gas provides protection by killing insect or arachnid larvae, eggs, or pupae in said enclosed environment that further comprises an agricultural product growing in said enclosed environment. In another aspect, the DHP gas provides protection by converting ethylene gas produced by agricultural products into carbon dioxide and water before the ethylene gas can promote decay.

In other aspects, the enclosed environment suitable for growing an agricultural product may be pre-treated with DHP gas prior to introducing the agricultural product for growing. In some aspects the enclosed environment is pretreated with DHP gas at a concentration of up to 10 ppm. In certain aspects, the time for pretreatment is one or more days. In some aspect the pretreatment time is 2 or 3 days. In other aspects, the time for pretreatment is one week. The disclosure provides for the pretreatment of the enclosed environment after the harvesting of a first agricultural product and before introducing a second agricultural product.

The present disclosure provides for, and includes, organic methods for crop production comprising providing DHP gas at a final concentration of at least 0.05 parts per million (ppm) to an enclosed environment containing an agricultural product and maintaining said DHP gas at a final concentration of at least 0.05 parts per million (ppm) for a time period during crop production. In certain aspects, the DHP gas concentration can be up to 10 ppm. It is evident that H₂O₂ reacts or is broken down to produce water and oxygen and no residue remains, accordingly this safe and effective method is wholly organic.

The present disclosure provides for, and includes, agricultural products after treatment with DHP gas according the methods of the present disclosure that are organic. The agricultural products after treatment have reduced levels of pathogens, reduced levels of pesticides, fungicides and other residues of compound that are often applied to the agricultural product during production. Whether the added compounds applied to the agricultural product are “organic” or not, due to the oxidative action of the H₂O₂ gas, the compounds accessible on the surface are necessarily reduced. Provided sufficient time, these compounds (and pathogens) can be essentially reduced to zero. When compared to untreated agricultural products, the methods of the present disclosure provide for reductions in compounds and pathogens of at least 10%. In other aspects the reduction is at least 50% or more. In certain aspects, the reduction is between 50% and 75%. In yet other aspects, the reduction is at least 80%. In yet other aspects, at least 90% of the applied compounds are reduced or broken down. Agricultural products having reduced bacteria and fungi are expected to last longer and, should there be any chemicals applied, the reduction in chemicals may provide for improved health benefits.

Various embodiments and aspects of the present invention as delineated hereinabove and as claimed in the claims section below find experimental support in the following Examples. The following Examples are presented for the purposes of illustration and should not be construed as limitations.

### EXAMPLES

### Example 1

### Laboratory Testing of DHP Gas for the Control of Mold on Perishable Fruit

The effects of DHP gas on a perishable food product is performed to determine the efficacy on controlling mold spoilage using the indirect dispersion of DHP gas in a space. Experiments are conducted in a 1584 cubic foot test room. The temperature of test room is maintained between 73° F. and 78° F., and the humidity of the ambient air is between 40% and 65%. Fresh strawberries are incubated in the test room for 5 days without DHP gas (control) or with DHP gas at a final concentration between 0.1 ppm and 0.4 ppm. After the 5-day incubation period, the strawberries are evaluated for the presence of mold spoilage. After the 5-day incubation period, control strawberries demonstrate significant mold spoilage. In contrast, strawberries incubated in the presence of DHP gas show no signs of mold spoilage. Sample results are shown in FIG. 1.

### Example 2

### DHP Gas Controls Bacteria and Fungi

To demonstrate the effectiveness of DHP gas on bacteria and fungi, test surfaces were inoculated with the bacteria and fungi as provided in Table 1. Control surfaces and test surfaces were placed in DHP gas free and DHP gas containing environments and sampled over a period of 24 hours to determine the organism count remaining.

TABLE 1
Reduction of Bacteria and Fungi
Exposed to DHP Gas Environment

| | | DHP Gas | Time to 90% | |
|---|---|---|---|---|
| Microbe | Number/inch² | (ppm) | reduction | |
| H1N1 virus | 1.12 × 10⁶ | 0.6 | 22.9 | minutes |
| MS2 bacteriophage | 1.25 × 10³ | 0.6 | <4 | hours |
| Feline calicivirus | ~1 × 10⁸ | 0.6 | <2 | hours |
| Streptococcus pyogenes | 5 × 10⁴ | 0.6 | <4 | hours |
| MRSA (without soil load) | 1 × 10⁵ | 0.6 | 2.6 | hours |
| MRSA (with soil load) | 0.5 × 10⁵ | 0.6 | 4.6 | hours |
| C. difficile (spores) | 3.78 × 10⁶ | 0.5-1.0 | 70.4% at | |
| | | | 24 hours | |
| Aspergillus Niger | 2.2 × 10⁴ | 0.3 | 7 | hours |
| (vegetative) | | | | |
| Enterococcus faecalis | | 0.5-1.0 | <2 | hours |

### Example 3

### Laboratory Testing of DHP Gas for the Control of Geobacillus Stearothermophilus Spores

The effects of DHP gas on Geobacillus stearothermophilus spores is performed to determine the efficacy on killing the spores using the indirect dispersion of DHP gas in a space. G. stearothermophilus spores were selected as they are particularly resistant to killing and are often used to validate steam sterilization methods. In these experiments, the mortality rates in G. stearothermophilus spores is assayed using filter strip impregnated with G. stearothermophilus spores which are subjected to DHP gas at a concentration of about 0.3 ppm. The test strips provide a visual readout following exposure to DHP gas for a specific period of time. The G. stearothermophilus impregnated test strips are first exposed to DHP gas and them dipped in a tryptic soy broth solution and placed on a dry bath for a 24-hour incubation period. Following the incubation period, each test strip is analyzed to determine the presence of any viable bacteria. A change in color or the presence turbidity prior to the expiration of the 24-hour incubation period indicates that viable spores remain following exposure to DHP gas. Conversely, an absence of a change in color or turbidity prior to the expiration of the 24-hour incubation period indicates the eradication of the G. stearothermophilus spores. The results are presented in Table 2 below.

TABLE 2
Effect of DHP Gas on Geobacillus stearothermophilus
spores in Laboratory Tests

| | Exposure to | Biological | Color Change |
|---|---|---|---|
| Spore | DHP Gas | Change/Time of | within 24 hour |
| Strip | (hours) | Change (hours) | incubation |
| Log3 | 40 | Heavy turbidity | +Light orange |
| Log3 | 42 | x | + |
| Log3 | 45.5 | x | + |
| Log3 | 47.75 | Less turbidity | +Dark orange |
| Log3 | 64.5 | x | + |
| Log3 | 70 | x | + |
| Log3 | 60.2 | x | + |
| Log3 | 64.2 | x | + |
| Log3 | 67.5 | x | + |
| Log3 | 85.1 | x | + |
| Log3 | 89 | x | + |
| Log3 | 100 | 16 | + |
| Log3 | 60.2 | Heavy turbidity | + |
| Log3 | 64.2 | x | + |
| Log3 | 67.5 | Almost no turbidity | + |
| Log3 | 85.1 | x | + |
| Log3 | 89 | x | + |
| Log3 | 100 | 22-24 | + |
| Log4 | 121.4 | almost no turbidity 8-15 | − |
| Log4 | 144 | almost no turbidity 17 | − |
| Log4 | 168 | | − |
| Log4 | 192 | 15 | − |
| Log4 | 223.5 | 14 | − |
| Log4 | 288 | no turbidity 17 | darker orange |
| Log4 | 121.4 | almost no turbidity 15 | − |
| Log4 | 144 | almost o turbidity 17 h | − |
| Log4 | 168 | | − |
| Log4 | 192 | 15 | − |
| Log4 | 223.5 | no turbidity 22 | light orange |
| Log2 | 288 | no turbidity 17 | very light orange |
| Log2 | 72 | turbidity 15 | light yellow |
| Log 2 | 144 | 22 | very dark orange |
| | | | almost light purple |
| Log 3 | 144 | no turbidity 16.5 | very light orange |
| Log 4 | 144 | no turbidity 16.5 | very light orange |
| Log 2 | 166.5 | | may have changed |
| | | | prior to 24 hours |
| | | | but still dark |
| Log 3 | 166.5 | | − |
| Log 4 | 166.5 | | − |
| Log 2 | 216 | no turbidity 22 | very dark orange |
| Log 3 | 216 | no turbidity 22 | very dark orange |
| Log 4 | 216 | no turbidity 22 | very dark orange |

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-121. (canceled)

122. A method for inhibiting an ethylene response in an agricultural product comprising:
providing dilute hydrogen peroxide (DHP) gas at a final concentration of up to 10.0 parts per million (ppm) to an enclosed environment containing said agricultural product; and
maintaining said concentration of DHP gas in said enclosed environment for a period of time.

123. The method of claim 122, wherein said inhibited ethylene response is selected from the group consisting of ripening, senescence, abscission, growth inhibition, growth stimulation, branching, tillering, seed development, flower development, seed germination, and breaking of seed dormancy.

124. The method of claim 123, wherein said agricultural product is selected from the group consisting of roots, tubers, rhizomes, bulbs, corms, stems, branches, leaf stems, bracts, leaf sheaths, leaves, needles, blooms, buds, flowers, petals, fruits, seeds, and edible fungi.

125. The method of claim 124, wherein said agricultural product is selected from the group consisting of achoccha, amaranth, angelica, anise, apple, arrowroot, arrugula, artichoke, globe, artichoke, jerusalem, asparagus, atemoya, avocado, balsam apple, balsam pear, bambara groundnut, bamboo, banana, plantains, barbados cherry, beans, beet, blackberry, blueberry, bok choy, boniato, broccoli, Chinese broccoli, raab broccoli, Brussels sprouts, bunch grape, burdock, cabbage, cabbage, sea-kale, swamp cabbage, calabaza, cantaloupes, muskmelons, capers, carambola (star fruit), cardoon, carrot, cassava, cauliflower, celeriac, celery, celtuce, chard, chaya, chayote, chicory, Chinese jujube, chives, chrysanthemum, chufa, cilantro, citron, coconut palm, collards, comfrey, corn salad, corn, cuban sweet potato, cucumber, cushcush, daikon, dandelion, dasheen, dill, eggplant, endive, eugenia, fennel, fig, galia muskmelon, garbanzo, garlic, gherkin, ginger, ginseng, gourds, grape, guar, guava, hanover salad, horseradish, huckleberry, ice plant, jaboticaba, jackfruit, jicama, jojoba, kale, kangkong, kohlrabi, leek, lentils, lettuce, longan, loquat, lovage, luffa gourd, lychee, macadamia, malanga, mamey sapote, mango, martynia, melon, casaba, melon, honeydew, momordica, muscadine grape, mushroom, muskmelons, mustard, mustard collard, naranjillo, nasturtium, nectarine, okra, onion, orach, oranges, papaya, paprika, parsley, parsley root, parsnip, passion fruit, peach, plum, peas, peanuts, pear, pecan, pepper, persimmon, pimiento, pineapple, pitaya, pokeweed, pomegranate, potato, sweet potato, pumpkin, purslane, radicchio, radish, rakkyo, rampion, raspberry, rhubarb, romaine lettuce, roselle, rutabaga, saffron, salsify, sapodilla, sarsaparilla, sassafrass, scorzonera, sea kale, seagrape, shallot, skirret, smallage, sorrel, soybeans, spinach, spondias, squash, strawberries, sugar apple, swamp cabbage, sweet basil, sweet corn, sweet potato, swiss chard, tomatillo, tomato, tree tomato, truffles, turnip, upland cress, water celery, waterchestnut, watercress, watermelon, yams, and zucchini.

126. The method of claim 122, wherein said ethylene response is ripening.

127. The method of claim 122, wherein said agricultural product is selected from the group consisting of an ornamental plant, flowering bulb, cut flower, edible potted plants, non-edible potted plants, and transplants.

128. The method of claim 122, further comprising providing cyclopropene or a cyclopropene derivative as a solid, a gas, a solution, or a carrier composition.

129. A method for protecting a fruit or vegetable comprising:
providing dilute hydrogen peroxide (DHP) gas at a final concentration of up to 10.0 parts per million (ppm) to an enclosed environment; and
maintaining said DHP gas at a final concentration of up to 10.0 ppm in said enclosed environment,
wherein said protecting comprises converting ethylene gas produced by a fruit or vegetable into carbon dioxide and water before the ethylene gas can promote decay.

130. The method of claim 129, wherein said protecting comprises:
preventing or inhibiting contamination of said fruit or vegetable growing in said enclosed environment by a virus or bacterium;
preventing or inhibiting damage and losses due to parasitic fungi on said fruit or vegetable growing in said enclosed environment;
preventing or inhibiting damage and losses due to parasitic fungi on the nutrient bed in which said fruit or vegetable grows in said enclosed environment;
preventing or inhibiting contamination of said fruit or vegetable by a virus or bacterium by providing and maintaining said DHP gas at a final concentration of up to 10.0 parts per million (ppm) for a time period prior to introducing plants that produce said fruit or vegetable to said enclosed environment for growing;
preventing or inhibiting damage and losses due to parasitic fungi on said fruit or vegetable by providing and maintaining said DHP gas at a final concentration of up to 10.0 parts per million (ppm) for a time period prior to introducing said agricultural product to said enclosed environment for growing; or
preventing or inhibiting damage and losses due to parasitic fungi on the nutrient bed in which said plants that produce said fruit or vegetable by providing and maintaining said DHP gas at a final concentration of at least 0.05 parts per million (ppm) for a time period prior to introducing plants that produce said fruit or vegetable to said enclosed environment for growing.

131. A method for preparing an air dried fruit vegetable, or herb, comprising:
placing said fruit or vegetable in an enclosed environment having dilute hydrogen peroxide (DHP) gas at a concentration of up to 10 parts per million (ppm) and having a relative humidity (RH) of less than 65%;
maintaining said fruit or vegetable in said enclosed environment until the water content of said fruit, vegetable, or herb is reduced to a final moisture content of about 25% or less.

132. The method of claim 131, wherein said RH is less than 50%.

133. The method of claim 131, wherein the water content of said fruit, vegetable, or herb is reduced to a final moisture content of about 15% or less.

134. The method of claim 131, wherein said fruit, vegetable, or herb is selected from the group consisting of green bean, broccoli, savoy cabbage, white cabbage, carrot, celery, cilantro, com, dill weed, garlic, kale, leek, mushroom, onion, parsley, peas, pepper, potato, pumpkin, shallot, spinach, squash, tomato, zucchini, apple, apricots, bananas, blueberries, cranberries, gooseberry, huckleberry, raspberry, black mulberry, strawberry, cherry, date, fig, grape, kiwi, kumquat, mango, nectarine, peach, papaya, pear, persimmon, pineapple, and plum.
